(19) United States
(12) Patent Application Publication
(10) Pub. No.: US 2025/0348025 A1
(43) Pub. Date: Nov. 13, 2025

(54) IMAGE FORMING APPARATUS

(71) Applicant: CANON KABUSHIKI KAISHA, Tokyo (JP)

(72) Inventors: KOHEI OKAYASU, Shizuoka (JP); JUN HARA, Kanagawa (JP); AKISATO SAKAKI, Kanagawa (JP)

(21) Appl. No.: 19/194,774

(22) Filed: Apr. 30, 2025

(30) Foreign Application Priority Data
May 7, 2024 (JP) 2024-075159

(51) Int. Cl. G03G 15/08

(52) U.S. Cl. CPC G03G 15/0891; G03G 15/0808; G03G 15/0875; G03G 15/0877; G03G 2215/068

(57) ABSTRACT

An image forming apparatus including: a photosensitive drum; a rotary configured to be rotatable around an axial direction; a toner cartridge configured to be supported by the rotary and have a discharge opening discharging toner, and a developing unit configured to be supported by the rotary, develop an electrostatic latent image formed on the photosensitive drum at a development position, and have a discharged receiving opening receiving toner, an accommodating chamber accommodating the received toner, a developing roller, a supply roller rotating around a roller axis along the axial direction and supplying the housed toner to the developing roller, and a guide portion, in which the guide portion guides toner moving in a direction intersecting the axial direction away from the receiving opening, is used.

### BACKGROUND OF THE INVENTION

### Field of the Invention

The present invention relates to an image forming apparatus.

### Description of the Related Art

In an image forming apparatus of an electrophotographic type, a rotary developing system in which a color image is formed by rotating a rotary including a plurality of developing units is known. Japanese Patent Application Publication No. 2007-183305 and Japanese Patent Application Publication No. 2008-096852 describe an image forming apparatus including a rotary including a plurality of developing units and a plurality of toner cartridges (toner accommodating containers) that can be attached/detached to/from the rotary.

When a developing unit is replenished with toner from a toner cartridge to, toner may remain inside of the developing unit near an opening portion that allows the toner cartridge and the developing unit to communicate with each other, which causes toner to be distributed non-uniformly inside of the developing unit. Due to such a non-uniform toner distribution, image defects such as concentration unevenness and the like may occur.

### SUMMARY OF THE INVENTION

Thus, an object of the present invention is to uniformly distribute toner inside of a developing unit in an image forming apparatus of a rotary developing system of a toner replenishment system.

The present invention provides an image forming apparatus comprising:
a photosensitive drum;
a rotary rotatable about a rotation axis extending in an axial direction;
a toner cartridge which is supported by the rotary and includes a discharge opening from which toner is discharged; and
a developing unit which is supported by the rotary and configured to develop an electrostatic latent image formed on the photosensitive drum at a development position, wherein
the developing unit has a receiving opening configured to receive the toner discharged from the discharge opening, an accommodating chamber configured to accommodate the toner received from the receiving opening, a developing roller configured to carry the toner, a supply roller configured to rotate about a roller axis extending along the axial direction to supply the toner accommodated in the accommodating chamber to the developing roller, and a guide portion, and
the guide portion is configured to guide the toner, which moves in a direction intersecting the axial direction in accordance with the rotation of the supply roller, away from the receiving opening in the axial direction.

According to the present invention, in an image forming apparatus of a rotary developing system of a toner replenishment system, toner inside of a developing unit can be uniformly distributed.

Further features of the present invention will become apparent from the following description of exemplary embodiments with reference to the attached drawings.

### BRIEF DESCRIPTION OF THE DRAWINGS

FIG. 1 is a schematic view of an image forming apparatus according to Example 1;

FIG. 2 is a configuration diagram of the image forming apparatus according to Example 1;

FIG. 3 is a schematic view of a developing unit, a toner cartridge, and a tray according to Example 1;

FIGS. 4A and 4B are cross-sectional views of the image forming apparatus according to Example 1;

FIG. 5 is a perspective view of a rotary main body according to Example 1;

FIGS. 6A to 6C are perspective views of the image forming apparatus according to Example 1;

FIGS. 7A and 7B are cross-sectional views of the image forming apparatus according to Example 1;

FIG. 8 is an explanatory diagram of the rotary main body according to Example 1;

FIG. 9 is a cross-sectional view of the rotary main body according to Example 1;

FIG. 10 is an explanatory diagram of the rotary main body according to Example 1;

FIGS. 11A and 11B are explanatory diagrams of a configuration relating to movement of a tray according to Example 1;

FIGS. 12A and 12B are cross-sectional views of a configuration relating to movement of the tray according to Example 1;

FIG. 13 is a diagram illustrating an internal structure of a toner cartridge according to Example 1;

FIG. 14 is a cross-sectional view illustrating an internal structure of the toner cartridge according to Example 1;

FIG. 15 is a schematic view illustrating a rotating rotary assembly according to Example 1;

FIG. 16 is a cross-sectional view illustrating convection of toner inside of the developing unit according to Example 1;

FIG. 17 is a cross-sectional view illustrating an internal structure of the developing unit according to Example 1 at a development position;

FIG. 18 is a schematic view illustrating an internal structure of the developing unit according to Example 1;

FIG. 19 is a perspective view illustrating an internal structure of the developing unit according to Example 1;

FIG. 20 is a cross-sectional view of an internal structure of a developing unit according to Example 2 at a development position;

FIG. 21 is a schematic view illustrating an internal structure of the developing unit according to Example 2; and

FIG. 22 is a perspective view illustrating an internal structure of the developing unit according to Example 2.

### DESCRIPTION OF THE EMBODIMENTS

Hereinafter, embodiments for performing the present invention will be described in detail as examples on the basis of examples with reference to the drawings. Dimensions, materials, shapes, relative arrangement, and the like of components described in this embodiment should be appropriately changed according to the configuration of a device to which the invention is applied and various conditions. In other words, there is no intention to limit the scope of the present invention to the following embodiments.

### Example 1

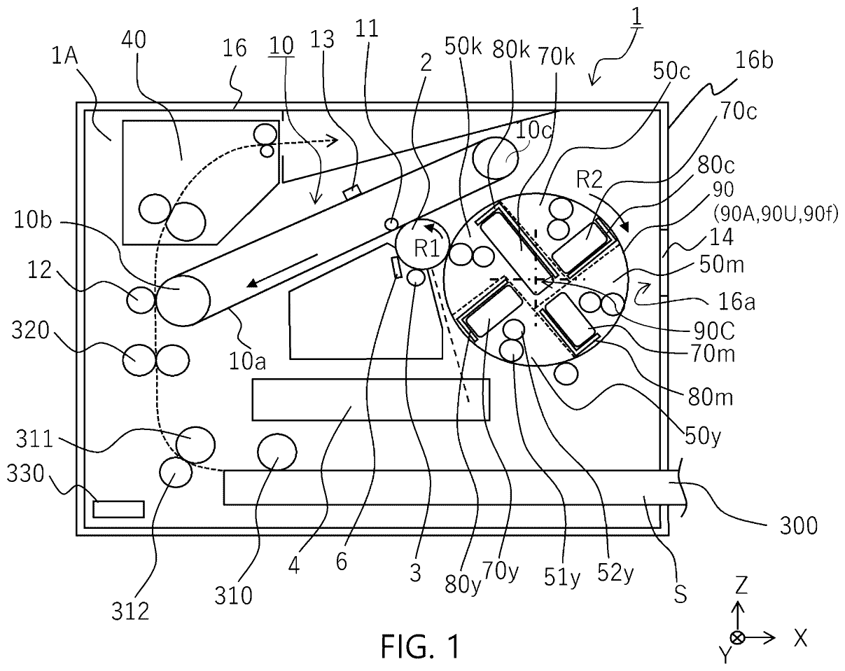

An image forming apparatus 1 according to Example 1 will be described with reference to FIGS. 1 to 12B and 17.

In the following description and in each drawing, a vertical direction of a case in which the image forming apparatus 1 is installed on a horizontal plane will be set as a Z direction. A direction that intersects the Z direction and is a direction of a rotation axis 90C of a rotary main body 90 (a rotation axis direction of a rotary) to be described below will be set as a Y direction. A direction that intersects both the Z direction and the Y direction will be set as an X direction. The X direction and the Y direction preferably represent a horizontal direction. It is preferable that the X direction, the Y direction, and the Z direction are orthogonal to each other. As is necessary, directions of arrows X, Y, and Z illustrated in each drawing will be respectively denoted as a +X side, +Y side, and +Z side, and sides opposite thereto will be respectively denoted as a −X side, −Y side, and −Z side.

### Entire Configuration of Image Forming Apparatus

First, the entire configuration of the image forming apparatus 1 will be described. The image forming apparatus 1 is a laser beam printer that forms an image on a sheet S using an electrophotographic system. More specifically, the image forming apparatus 1 is a color laser beam printer including four developing units 50y, 50m, 50c, and 50k. As a sheet S that is a recording material (a recording medium), a variety of sheet materials of different sizes and materials including a paper sheet such as a plain paper sheet or a cardboard, a sheet material for which a surface treatment has been performed such as a plastic film, a cloth, or a coated sheet, or a special-shaped sheet material such as an envelope or an index paper sheet can be used.

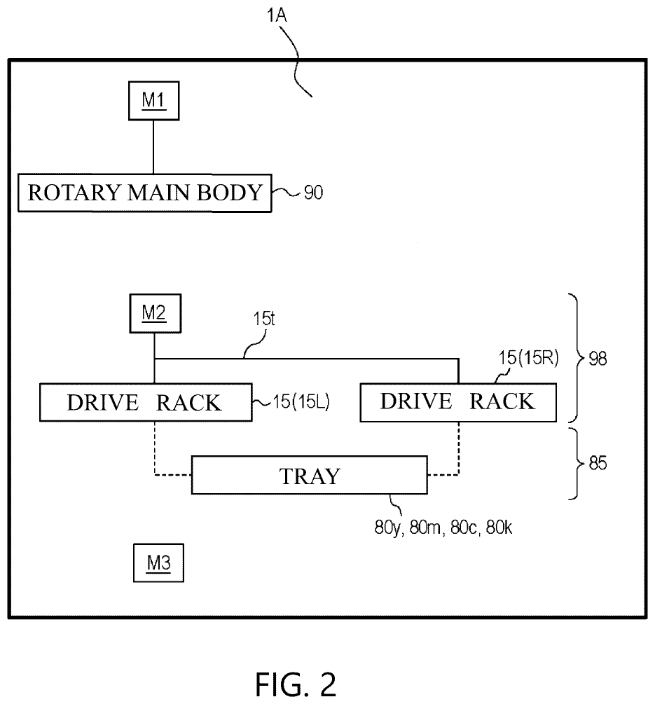

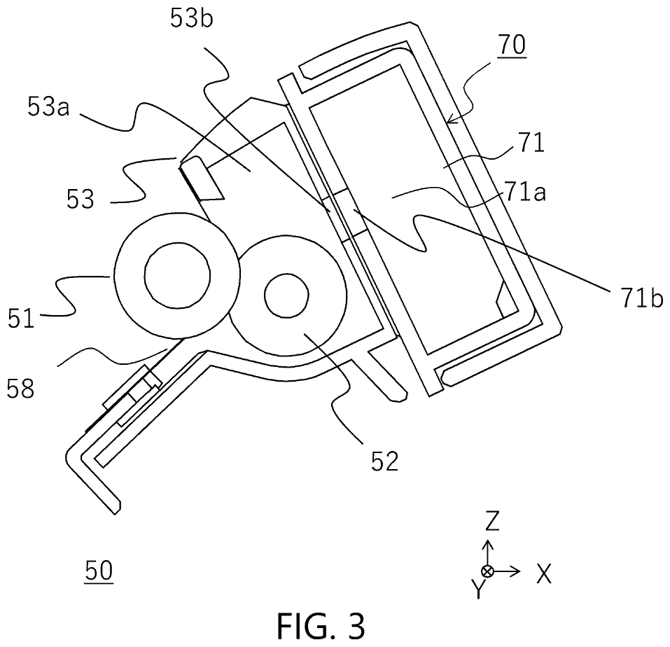

A schematic configuration and an image forming operation of the image forming apparatus 1 will be described with reference to FIGS. 1, 2, and 3. FIG. 1 is a schematic view illustrating a cross-section configuration of the image forming apparatus 1. FIG. 2 is a diagram illustrating a drive source of the image forming apparatus 1. FIG. 3 is a schematic view illustrating a configuration for replenishing toner from a toner cartridge 70 to a developing unit 50.

As illustrated in FIG. 1, the image forming apparatus 1 has an image forming apparatus main body (hereinafter, referred to as an apparatus main body) 1A and toner cartridges 70y, 70m, 70c, and 70k that can be attached/detached to/from the apparatus main body 1A. The apparatus main body 1A according to this example is a portion acquired by excluding the toner cartridges 70y, 70m, 70c, and 70k from the image forming apparatus 1.

The apparatus main body 1A of the image forming apparatus 1 has an electrophotographic photosensitive body (hereinafter, referred to as a photosensitive drum 2) having a drum shape (a cylindrical shape) as an image carrier carrying an electrostatic latent image. On the periphery of the photosensitive drum 2, a charging roller 3, a scanner 4 as an exposure device, and a cleaning unit 6 are disposed.

The charging roller 3 is an example of a charging means or a charging unit used for uniformly charging the photosensitive drum 2. The scanner 4 is an example of an exposure means or an exposure unit that performs exposure by emitting a laser beam corresponding to image information to the photosensitive drum 2. By emitting a laser beam to the photosensitive drum 2 after charging, an electrostatic latent image is formed on the surface of the photosensitive drum 2. The cleaning unit 6 is an example of a cleaning means or a cleaning unit that removes toner remaining on the surface of the photosensitive drum 2.

In addition, the apparatus main body 1A has a sheet housing portion 300, a pickup roller 310, a feed roller 311, a separation roller 312, a conveyance roller pair 320, a secondary transfer roller 12, a fixing device 40, and an intermediate transfer unit 10. The pickup roller 310 is an example of a feeding means or a feeding unit that feeds a sheet S. The feed roller 311 and the separation roller 312 represent an example of a separation/conveyance unit that conveys sheets S while separating them one by one by a frictional force. The secondary transfer roller 12 is an example of a transfer means or a transfer unit that transfers an image onto a sheet S from the intermediate transfer belt 10a.

The intermediate transfer unit 10 has an intermediate transfer belt 10a, a belt driving roller 10b, a tension roller 10c, a cleaning device 13, and a primary transfer roller 11. The intermediate transfer belt 10a is an example of an intermediate transfer body that carries an image transferred from the photosensitive drum 2 (primary transfer) and transfers it to a sheet S for transfer (secondary transfer). The intermediate transfer belt 10a is stretched over the belt driving roller 10b and the tension roller 10c. The belt driving roller 10b is a drive member that conveys the intermediate transfer belt 10a by being rotated and driven by a drive source.

In addition, the apparatus main body 1A has a rotary main body (a rotary, a rotating body, and a developing device) 90 that has the developing units 50y, 50m, 50c, and 50k. As will be described below, in this example, trays (support members) 80y, 80m, 80c, and 80k are attached to the rotary main body 90. The toner cartridges 70y, 70m, 70c, and 70k are respectively detachably attached to the trays 80y, 80m, 80c, and 80k.

In the following description, a plurality of members and the like of which functions are similar to each other can be identified by assigning numbers thereto. For example, one among the toner cartridges 70y, 70m, 70c, and 70k can be referred to as a first toner cartridge, one among the remaining three toner cartridges can be referred to as a second toner cartridge, one toner cartridge out of the remaining two toner cartridges can be referred to as a third toner cartridge, and the last one can be referred to as a fourth toner cartridge. Similarly, one among the trays 80y, 80m, 80c, and 80k can be referred to as a first tray, one among the remaining three trays can be referred to as a second tray, one tray out of the remaining two trays can be referred to as a third tray, and the last one can be referred to as a fourth tray. In other words, one of the trays 80y to 80k is an example of a first support member, another one of the trays 80y to 80k is an example of a second support member, a further another one of the trays 80y to 80k is an example of a third support member, and the last one of the trays 80y to 80k is an example of a fourth support member. Such number assignment is used only for the convenience of description, and the numbers can be interchanged as appropriate in principle.

The developing units (first to fourth developing units) 50y, 50m, 50c, and 50k are examples of a developing means or a developing unit that develops electrostatic latent images formed on the photosensitive drum 2 into toner images using toners of colors corresponding thereto. The developing units 50y, 50m, 50c, and 50k respectively develop the electrostatic latent images formed on the photosensitive drum 2 using yellow toner, magenta toner, cyan toner, or black toner The developing units 50y, 50m, 50c, and 50k may be arranged in an order different from the order illustrated in FIG. 1. The developing unit 50y has a developing roller 51y and a supply roller 52y.

The developing roller 51y is formed in a roller shape, with a silicone rubber layer (an elastic rubber layer) having semi-conductivity that is acquired by a conductivity agent being incorporated being concentrically disposed around a core also serving as an electrode, as a conductive support body. Furthermore, the surface layer of the silicone rubber layer is coated with an acrylic/urethane rubber layer.

The supply roller is a developer carrier that rotates while carrying toner as a developer and supplies the toner to the photosensitive drum 2. The supply roller 52y is a supply member that is arranged to be in contact with the developing roller 51y and supplies toner to the developing roller 51. In this example, the supply roller 52y is an elastic roller. More specifically, a urethane foam layer, which is a foaming layer composed of continuous bubbles (continuous foam) in which bubbles are connected to each other, is provided concentrically in a roller shape around a core as a conductive support body. For example, sponge is used as a foam body that constitutes the elastic roller.

The developing blade 58y is a regulating member that regulates the thickness of the toner layer carried on the developing roller 51y. The other developing units 50m, 50c, and 50k respectively include similar developing rollers 51m, 51c, and 51k, supply rollers 52m, 52c, and 52k, and developing blades 58m, 58c, and 58k as well.

In the rotary main body 90, toner cartridges 70y, 70m, 70c, and 70k respectively corresponding to the developing units 50y, 50m, 50c, and 50k are mounted. Inside of the toner cartridges 70y, 70m, 70c, and 70k, yellow toner, magenta toner, cyan toner, and black toner are housed as toner with which the developing units 50y, 50m, 50c, and 50k are replenished. One of the toners of four colors can be referred to as a first toner, one among the toners of the remaining three colors can be referred to as a second toner, one out of the toners of the remaining two colors can be referred to as a third toner, and the last toner can be referred to as a fourth toner. For example, black toner can be regarded as an example of the first toner and magenta toner is an example of the second toner. Such number assignment is used for the convenience of description and can be interchanged as appropriate in principle.

Here, the rotary main body 90 has a rotary frame 90f that supports the developing units 50y, 50m, 50c, and 50k. The developing units 50y, 50m, 50c, and 50k are supported by the rotary frame 90f that is a rotation supporting body.

The trays 80y, 80m, 80c, and 80k are attached to the rotary main body 90. A combined portion of the rotary main body 90 and the trays 80y, 80m, 80c, and 80k can be referred to as a rotary unit 90U. In other words, the rotary unit 90U has the rotary main body 90 and the trays 80y, 80m, 80c, and 80k.

The toner cartridges 70y to 70k are held to be attachable/detachable to/from the trays 80y to 80k. As will be described below, the trays 80y to 80k are supported to be able to slide up to the outside of the rotary main body 90. A combined portion of the rotary unit 90U and the toner cartridges 70y, 70m, 70c, and 70k can be referred to as a rotary assembly 90A. In other words, the rotary assembly 90A has the rotary unit 90U and the toner cartridges 70y, 70m, 70c, and 70k.

As will be described below, the rotary main body 90 is rotatable around a rotation axis (rotation center) 90C. The rotation axis 90C coincides with rotation axis of the rotary frame 90f, the rotary unit 90U, and the rotary assembly 90A. The rotation axis 90C is substantially parallel to the rotation axis (the rotation center) of the photosensitive drum 2.

The rotary main body 90 can take a development posture in which one of the developing rollers 51y, 51m, 51c, and 51k faces the photosensitive drum 2 by rotating around the rotation axis 90C. A posture in which the developing roller 51y faces the photosensitive drum 2 will be referred to as a yellow development posture. A posture in which the developing roller 51m faces the photosensitive drum 2 will be referred to as a magenta development posture. A posture in which the developing roller 51c faces the photosensitive drum 2 will be referred to as a cyan development posture. A posture in which the developing roller 51k faces the photosensitive drum 2 will be referred to as a black development posture. In other words, the rotary main body 90 can rotate around the rotation axis 90C such that the positions of the developing rollers 51y, 51m, 51c, and 51k with respect to the photosensitive drum 2 change. The black development posture is an example of a first development posture in which a first developing roller (the developing roller 51k) faces the photosensitive drum 2. The other development postures are examples of a second development posture in which a second developing roller (the developing rollers 51y to 51c) faces the photosensitive drum 2. The yellow/magenta/cyan/black development postures can also be referred to as first to fourth development postures. Such number assignment is used for the convenience of description and can be interchanged as appropriate in principle.

The control unit 330 transmits/receives information to/from each component inside of the apparatus and an external host apparatus and controls various operations including an image forming operation. For example, as the control unit 330, a computer, a processing circuit, or the like that includes computing resources such as a processor and memory and operates in accordance with a program or a user instruction input can be used.

As illustrated in FIG. 2, the apparatus main body 1A has motors M1, M2, and M3 as drive sources. As described below, the motor M1 supplies a driving force to rotate the rotary main body 90 around the rotation axis 90C. In other words, the motor M1 rotates the rotary assembly 90A and the rotary unit 90U around the rotation axis 90C.

In addition, the apparatus main body 1A has a drive device 98 that includes a motor M2 and a transmission device. The transmission device includes drive racks 15L and 15R as drive gears to be described below and a transmission unit 15t. The driving force of the motor M2 is transmitted to the drive racks 15L and 15R by the transmission unit 15t. In other words, the motor M2 is configured to drive the drive racks 15L and 15R and moves the trays 80y, 80m, 80c, and 80k with respect to the rotary main body 90 through the drive racks 15L and 15R.

A motor M3 drives members other than members driven by the motors M1 and M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing device 40.

The members driven by the motors M1, M2, and M3 can be changed as appropriate. The roles of arbitrary two or all the three of the motors M1, M2, and M3 can also be aggregated into one motor. On the other hand, a drive source other than the motors M1, M2, and M3 may be added.

Here, the subscripts y, m, c, and k attached to the developing units 50y, 50m, 50c, and 50k, the toner cartridges 70y, 70m, 70c, and 70k, the trays 80y, 80m, 80c, and 80k, and the like indicate colors of toner. The basic configurations and functions of the developing units 50y, 50m, 50c, and 50k are common. The basic configurations and functions of the toner cartridges 70y, 70m, 70c, and 70k are common. The basic configurations and functions of the trays 80y, 80m, 80c, and 80k are common. Thus, in a case in which there is no need to distinguish therebetween, the subscripts y, m, c, and k are omitted, and each thereof will be described as being an arbitrary one of the four units, four cartridges, or four trays.

As illustrated in FIG. 3, the toner cartridge 70 has a toner frame 71. The toner frame 71 has a toner accommodating portion 71a that houses toner and a discharge opening 71b that communicates with the toner accommodating portion 71a.

The developing unit 50 has a developing frame 53 (accommodating frame). The developing frame 53 has a developing accommodating chamber 53a (an accommodating chamber; a toner supply chamber), a reception opening 53b (a receiving opening) that communicates with the developing accommodating chamber 53a, a developing roller 51, and a supply roller 52.

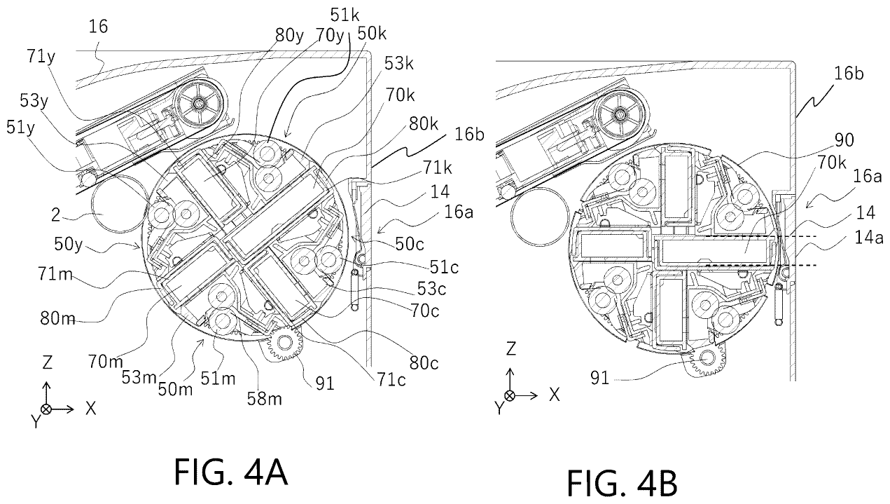

The developing roller 51k included in the developing unit 50k is an example of a first developing roller. The developing roller 51m included in the developing unit 50m is an example of a second developing roller. The developing frame 53k (FIG. 4A) of the developing unit 50k including the developing accommodating chamber 53a is an example of a first accommodating frame including a first accommodating part. The developing frame 53m (FIG. 4A) of the developing unit 50m including the developing accommodating chamber 53a is an example of a second accommodating frame including a second accommodating part. The rotary main body 90 is an example of a rotary, which can rotate, having a first developing roller, a second developing roller, a first accommodating frame including a first accommodating part, and a second accommodating frame including a second accommodating part. In this example, the rotary main body 90 has first to fourth developing rollers and first to fourth accommodating frames.

As will be described below, the toner cartridge 70 can be moved with respect to the developing frame 53 to a mounting position and a retraction position retracted from the mounting position. In a state in which the toner cartridge 70 is at the mounting position with respect to the developing frame 53, the discharge opening 71b faces the reception opening 53b. In other words, the toner accommodating portion 71a of the toner cartridge 70 and the developing accommodating chamber 53a of the developing unit 50 communicate with each other through the discharge opening 71b and the reception opening 53b. When toner is replenished from the toner cartridge 70 to the developing unit 50, at least a portion of the reception opening 53b is positioned below at least a portion of the discharge opening 71b.

The toner housed in the toner accommodating portion 71a is discharged from the discharge opening 71b, and the toner discharged from the discharge opening 71b is housed in the developing accommodating chamber 53a through the reception opening 53b. The toner housed in the developing accommodating chamber 53a is supplied to the developing roller 51 by the supply roller 52. Through such a route, the toner housed in the toner accommodating portion 71a is supplied to the developing roller 51.

It is preferable that the toner cartridge 70 have a sealing member (a first sealing member), which is not illustrated, covering the discharge opening 71b. It is preferable that the developing unit 50 have a sealing member (a second sealing member), which is not illustrated, covering the reception opening 53b. In a state in which the toner cartridge 70 is not mounted in the developing unit 50, it is preferable that the discharge opening 71b and the reception opening 53b be covered with sealing members such that toner is prevented from flowing out of the discharge opening 71b and the reception opening 53b.

### Image Forming Operation

An image forming operation according to this example will be described. Each process in the image forming operation is executed by the control unit 330 controlling each component of the apparatus. First, the photosensitive drum 2 is rotated in an arrow direction (counterclockwise) illustrated in FIG. 1 in synchronization with the rotation of the intermediate transfer belt 10a. Then, the surface of the photosensitive drum 2 is uniformly charged by the charging roller 3.

In a case in which a color image is formed on a sheet S, as below, the rotary main body 90 rotates in the arrow direction (clockwise) illustrated in FIG. 1 while supporting the developing units 50y, 50m, 50c, and 50k. Then, an electrophotographic process is repeatedly performed while moving one of the developing rollers 51y, 51m, 51c, and 51k to the development position each time.

First, the scanner 4 emits a laser beam based on image data corresponding to a yellow image to form an electrostatic latent image corresponding to the yellow image on the surface of the photosensitive drum 2. In parallel with the formation of this electrostatic latent image, the motor M1 rotates the rotary main body 90 to cause the rotary main body 90 to take the yellow development posture. When the rotary main body 90 is taking the yellow development posture, the developing roller 51y is at the development position and develops the electrostatic latent image formed on the photosensitive drum 2 with yellow toner.

Here, in this example, each of the developing rollers 51y, 51m, 51c, and 51k is an elastic roller in which the periphery of a metal shaft is coated with a rubber. At the development position, each of the developing rollers 51y, 51m, 51c, and 51k develops an electrostatic latent image in the state of being in contact with the photosensitive drum 2. In other words, the image forming apparatus 1 according to this example employs a contact development system. However, at the development position, each of the developing rollers 51y, 51m, 51c, and 51k may develop an electrostatic latent image in a state in which a gap from the photosensitive drum 2 is formed. In other words, the image forming apparatus 1 may employ a non-contact developing system.

When a yellow toner image is developed, the yellow toner image on the photosensitive drum 2 is primary transferred to the intermediate transfer belt 10a by the primary transfer roller 11 disposed on the inner side of the intermediate transfer belt 10a.

Thereafter, by moving the developing rollers 51m, 51c, and 51k to the development position in order by rotating the rotary main body 90, a toner image of each color is formed. In other words, after a yellow toner image is formed on the intermediate transfer belt 10a, the rotary main body 90 takes the magenta development posture, and a magenta toner image is formed on the intermediate transfer belt 10a. After the magenta toner image is formed on the intermediate transfer belt 10a, the rotary main body 90 takes the cyan development posture, and a cyan toner image is formed on the intermediate transfer belt 10a. After the cyan toner image is formed on the intermediate transfer belt 10a, the rotary main body 90 takes the black development posture, and a black toner image is formed on the intermediate transfer belt 10a. After the black toner image is formed on the intermediate transfer belt 10a, the rotary main body 90 rotates around the rotation axis 90C in the arrow direction illustrated in FIG. 1 (clockwise) to return to the yellow development posture. The color of an image that is formed first for the intermediate transfer belt 10a is arbitrary, and, for example, a black toner image may be formed first.

Then, by repeating primary transfer such that four color toner images are superimposed on the intermediate transfer belt 10a, a color image is formed on the intermediate transfer belt 10a. Until the color image is formed on the intermediate transfer belt 10a, the secondary transfer roller 12 and the cleaning device 13 are not in contact with the intermediate transfer belt 10a.

Meanwhile, sheets S are fed from the sheet housing portion 300 disposed in a lower portion of the apparatus main body 1A by the pickup roller 310. The sheets S are sent to the conveyance roller pair 320 in a state in which the sheets are separated one by one by the feed roller 311 and the separation roller 312. The conveyance roller pair 320 sends out the sent sheet S to a transfer portion (a secondary transfer part) that is a nip portion between the intermediate transfer belt 10a and the secondary transfer roller 12. The color image on the intermediate transfer belt 10a is transferred (secondary transfer) to the surface of the conveyed sheet S.

A sheet S onto which the color image has been transferred is sent to the fixing device 40. In the fixing device 40, a sheet S is heated and pressurized to fix the image on the sheet S. The sheet S that has passed through the fixing device 40 is discharged to the outside of the image forming apparatus 1 as a result.

On the other hand, in a case in which a monochrome image is to be formed on a sheet S, the rotary main body 90 takes the black development posture. In this state, after an electrostatic latent image is formed on the surface of the photosensitive drum 2 through charging and exposure of the photosensitive drum 2, the electrostatic latent image is developed with black toner by the developing roller 51k positioned at the development position. The black toner image is primarily transferred onto the intermediate transfer belt 10a and then is secondarily transferred onto a sheet S. The process performed thereafter is similar to that of the case of a color image.

### Configuration of Rotary

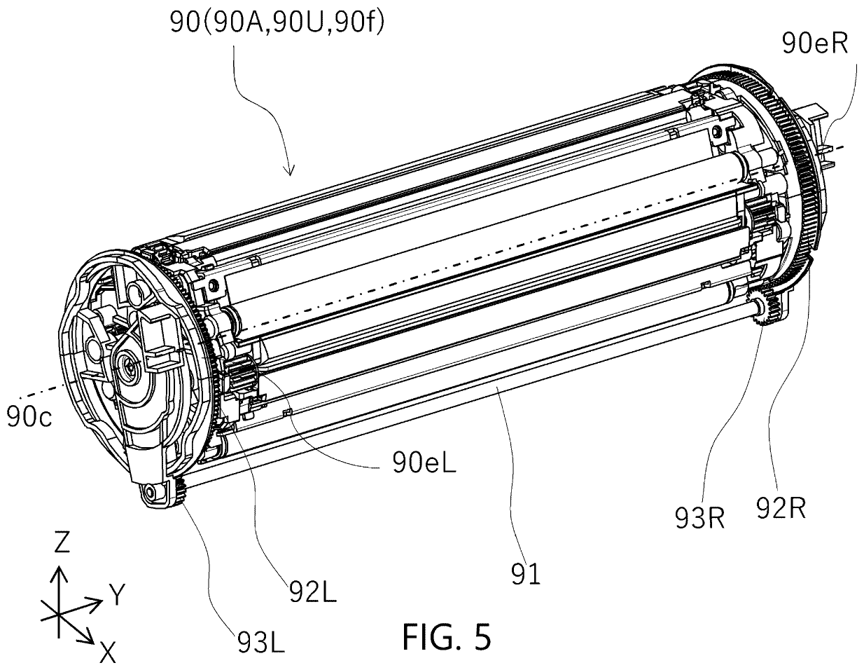

The configuration of the rotary main body 90 will be described with reference to FIGS. 1, 4A, 4B, and 5. FIGS. 4A and 4B are cross-sectional views illustrating the rotary main body 90 of the image forming apparatus 1 and the periphery thereof. FIGS. 4A and 4B are cross-sectional views of the apparatus cut along an imaginary plane perpendicular to the rotation axis 90C of the rotary main body 90. FIG. 5 is a perspective view of the rotary main body 90.

As described above, the toner cartridges 70y to 70k can be detachably attached to the rotary main body 90. In a case in which toner inside of the toner cartridges 70y to 70k has run out, a user can replenish toner in the image forming apparatus 1 by replacing the toner cartridges 70y to 70k.

As illustrated in FIG. 1, the apparatus main body 1A has a frame 16 that houses the rotary main body 90. The frame 16 is a main body frame of the image forming apparatus 1 according to this example. The frame 16 is a casing (a body) of the apparatus main body 1A composed of a frame and an exterior member and has an approximately rectangular shape in this example.

The frame 16 includes an opening 16a. More specifically, the frame 16 has a side surface 16b that extends in a direction intersecting with the horizontal direction.

The side surface 16b configures at least a portion of an exterior surface of the apparatus main body 1A on the +X side. The opening 16a is disposed on this side surface 16b. The side surface 16b is a side surface disposed on a downstream side of a discharge opening in a discharge direction in which a sheet S, on which an image has been formed, is discharged from the discharge opening of the apparatus main body 1A. From the side surface 16b of the image forming apparatus 1, a user can perform replenishment of a sheet S by accessing the sheet housing portion 300 or acquire a sheet S discharged from the discharge opening. For this reason, the side surface 16b can be regarded as a front surface (a forward surface) of the apparatus main body 1A.

The toner cartridges 70y, 70m, 70c, and 70k can be attached/detached to/from the rotary main body 90 through the opening 16a. In other words, the toner cartridge 70k can be regarded as an example of a first toner cartridge that houses toner supplied to the first developing roller (the developing roller 51k) and can be attached/detached to/from the rotary (the rotary main body 90) through the opening 16a of the frame 16 of the apparatus main body 1A. The toner cartridge 70m can be regarded as an example of a second toner cartridge that houses toner supplied to the second developing roller (the developing roller 51m) and can be attached/detached to/from the rotary (the rotary main body 90) through the opening 16a of the frame 16 of the apparatus main body 1A.

In this example, the toner cartridges 70y, 70m, 70c, and 70k are attached/detached to/from the rotary main body 90 through the opening 16a in a state of being respectively supported by the trays 80y to 80k. In other words, a user can attach/detach the toner cartridges 70y to 70k to/from the rotary main body 90 respectively through the trays 80y to 80k.

The opening 16a is arranged on the side surface 16b of the frame 16. In this embodiment, the side surface 16b is a surface that is approximately parallel to the rotation axis 90C of the rotary main body 90. For this reason, in a case in which the toner cartridge 70 is to be replaced, the toner cartridge 70 passes through the opening 16a in a direction intersecting (preferably a direction orthogonal to) the rotation axis 90C.

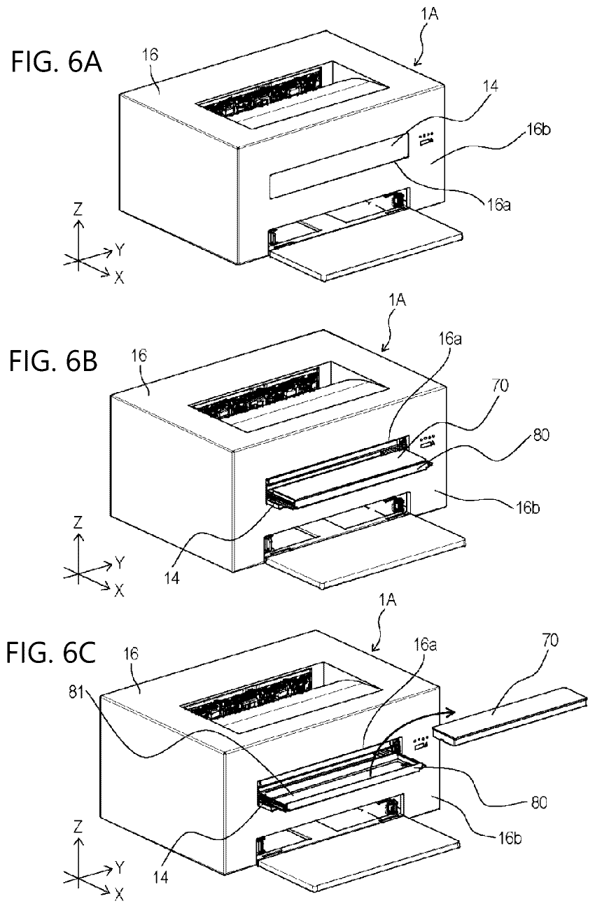

The image forming apparatus 1 has a door 14 that covers the opening 16a of the frame 16. The door 14 is an open/close member that can be moved to a closing position (see also FIG. 6A) causing the opening 16a to be covered and an opening position (see also FIGS. 6B and 6C) causing the opening 16a to be exposed.

As described above, in this example, the toner cartridge 70 is configured to be able to be attached/detached to/from the rotary main body 90 through the tray 80. For this reason, the toner cartridge 70 can be stably attached/detached to/from the rotary main body 90.

More specifically, a user can replace the toner cartridge 70 by performing an operation of attaching/detaching the toner cartridge 70 to/from the tray 80 that is configured to be movable with respect to the rotary main body 90 (that is, with respect to the apparatus main body 1A). In the case of a configuration in which a user replaces a toner cartridge by directly inserting/extracting the toner cartridge into/from the apparatus main body, the user is required to insert the toner cartridge up to a predetermined mounting position inside of the apparatus main body. In this example, the tray 80 can be moved such that the toner cartridge 70 can be moved to the mounting position in a state in which it supports the toner cartridge 70. For this reason, a user can replace a toner cartridge 70 by performing a simple operation of loading the toner cartridge 70 into the tray 80, and thus, the operability is improved.

The toner cartridge 70 has a shape elongated in a Y direction that is parallel to the rotation axis 90C of the rotary main body 90 as the Y direction. In other words, the dimensions of the toner cartridge 70 in the Y direction are larger than its height and width in a cross-section orthogonal to the Y direction. In the case of handling the toner cartridge 70 with such an elongated shape, by arranging the opening 16a on the side surface 16b of the frame 16 that is approximately parallel to the Y direction (Y direction) of the toner cartridge 70, the toner cartridge 70 can be caused to pass through the opening 16a in a short movement distance. For example, the replacement of the toner cartridge 70 can be performed more easily than in a case in which the toner cartridge 70 is inserted or extracted through an opening arranged on a side surface of any one side (the +Y side or the −Y side) of the frame 16 in the Y direction of the toner cartridge 70.

By rotating the rotary main body 90 around the rotation axis 90C, the rotary main body 90 can take a replacement posture in which detachment of any one of the toner cartridges 70y to 70k from the rotary main body 90 is allowed. A posture in which detachment of the toner cartridge 70y is allowed will be referred to as a yellow replacement posture. A posture in which detachment of the toner cartridge 70m is allowed will be referred to as a magenta replacement posture. A posture in which detachment of the toner cartridge 70c is allowed will be referred to as a cyan replacement posture.

A posture in which detachment of the toner cartridge 70k is allowed will be referred to as a black replacement posture. The black replacement posture is an example of a first replacement posture in which detachment of the first toner cartridge from the rotary main body 90 is allowed. The yellow/magenta/cyan replacement postures are examples of a second replacement posture in which detachment of the second toner cartridge from the rotary main body 90 is allowed. The yellow/magenta/cyan/black replacement postures can also be referred to as first to fourth replacement postures. Such number assignment is used for the convenience of description and can be interchanged as appropriate in principle.

The rotary main body 90 can sequentially take the yellow/magenta/cyan/black replacement postures by rotating around the rotation axis 90C in a clockwise direction illustrated in FIG. 1. In this embodiment, as the rotary main body 90 rotates clockwise around the rotation axis 90C illustrated in FIG. 1, switching between a development posture and a replacement posture is performed. For example, in FIG. 1, the rotary main body 90 takes the black development posture. From this state, the rotary main body 90 rotates clockwise to switch the posture of the rotary main body 90 in order of the cyan replacement posture, the yellow development posture, the black replacement posture, the magenta development posture, the yellow replacement posture, the cyan development posture, and the magenta replacement posture. As the rotary main body 90 rotates clockwise from the magenta replacement posture, the rotary main body 90 returns to the black development posture. In other words, the rotary main body 90 can rotate clockwise one revolution) (360° or more.

For example, when the rotary main body 90 is taking the black replacement posture, the developing unit 50k can be regarded to be at the attachment/detachment position. When the rotary main body 90 is taking the black development posture, the developing unit 50k can be regarded to be at the development position. Here, in a case in which the developing unit 50k is at the development position and in a case in which the developing unit 50k is at the attachment/detachment position, when the developing unit 50k is viewed, a positional relation between the supply roller 52k and a developing guide portion 53g to be described below is different in at least one of the vertical direction and the horizontal direction.

FIG. 4A illustrates a cross-section of the rotary main body 90 in a state in which a development posture (more specifically, the yellow development posture) is taken. FIG. 4B illustrates a cross-section of the rotary main body 90 in a state in which a replacement posture (more specifically, the black replacement posture) is taken.

As illustrated in FIGS. 4A and 4B, four trays 80y to 80k are attached to the rotary main body 90. In the trays 80y to 80k, the toner cartridges 70y to 70k are held. In FIGS. 4A and 4B, the trays 80y to 80k are in the state of being housed inside of the rotary main body 90, and this state can be regarded as a state in which the toner cartridges 70y to 70k are respectively mounted in the developing units 50y, 50m, 50c, and 50k.

As described above, the toner cartridge 70 can be moved with respect to the developing frame 53 of the developing unit 50 to the mounting position and to the retraction position retracted from the mounting position. In other words, the first toner cartridge (the toner cartridge 70k) can be moved to a first mounting position and a first retraction position with respect to the first accommodating frame (the developing frame 53k). The second toner cartridge (the toner cartridge 70m) can be moved to a second mounting position and a second retraction position with respect to the second accommodating frame (the developing frame 53m).

In a state in which the toner cartridge 70 is at the mounting position with respect to the developing frame 53, as illustrated in FIG. 3, the discharge opening 71b and the reception opening 53b face each other. In this state, the toner cartridge 70 is configured to supply toner to the developing accommodating chamber 53a through the reception opening 53b (the opening of the accommodating frame).

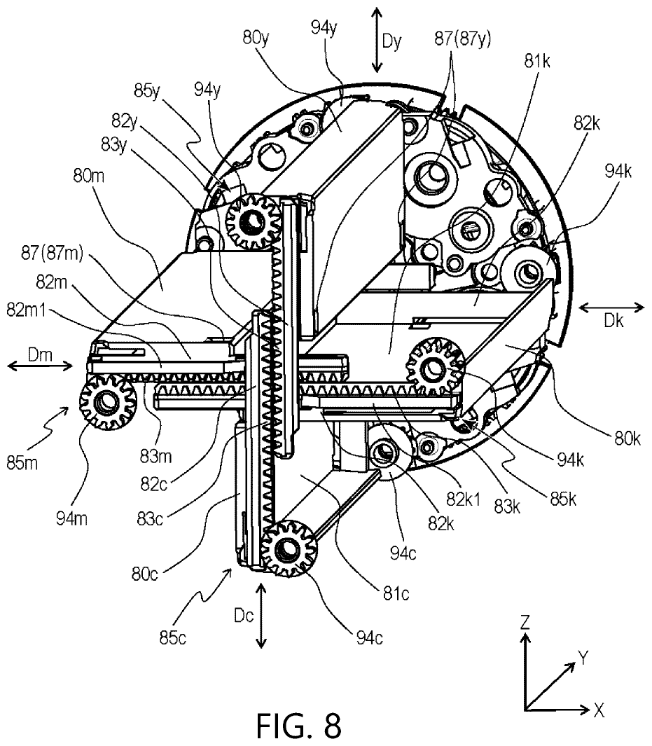

The apparatus main body 1A has a movement device 85 configured to move the toner cartridge 70 from the mounting position to the retraction position with respect to the rotary main body 90 (more specifically, with respect to the developing frame 53 of the developing unit 50). The movement device 85 will be described below with reference to FIG. 8 and the like. In this example, a plurality of movement devices 85y to 85k respectively corresponding to the plurality of toner cartridges 70y to 70k are arranged in the rotary main body 90. The trays 80y to 80k can be regarded as parts of these movement devices 85y to 85k.

In this example, the toner cartridge 70k accommodating black toner is larger in size than the toner cartridges 70y to 70c respectively accommodating yellow toner, magenta toner, and cyan toner and can house more toner than that of the toner cartridges 70y to 70c. In other words, the first toner cartridge can house a first amount of toner, the second toner cartridge can house a second amount of toner, and the first amount can be regarded to be larger than the second amount.

More specifically, the length of the black toner cartridge 70k in a first radial direction with respect to the rotation axis 90C of the rotary main body 90 is larger than the length of the magenta toner cartridge 70m in a second radial direction. Here, the first radial direction is the direction of the radius of rotation of the rotary main body 90 (the radial direction of a virtual circle having the rotation axis 90C as its center) and is a direction in which the toner cartridge 70k extends with respect to the rotation axis 90C when viewed in the direction of the rotation axis 90C. The second radial direction is a direction of the radius of rotation of the rotary main body 90 and is a direction in which the toner cartridge 70m extends with respect to the rotation axis 90C when viewed in the direction of the rotation axis 90C. Similarly, the length of the black toner cartridge 70k in the first radial direction is larger than the length of the other toner cartridges 70y and 70c in a radial direction corresponding to the toner cartridges 70y and 70c.

For this reason, the tray 80k holding the black toner cartridge 70k is larger in size than the trays 80y to 80c respectively holding the other toner cartridges 70y, 70m, and 70c. In other words, four toner cartridges 70y to 70k and trays 80y to 80k of different sizes are arranged inside of the rotary main body 90. In other words, the toner cartridge 70k as an example of a first toner cartridge and the toner cartridge 70y as an example of a second toner cartridge that is smaller in size than the first toner cartridge can be attached/detached to/from the rotary main body 90. In accordance with this, in the rotary main body 90, the tray 80k as an example of a first support member that supports the first toner cartridge and the tray 80y as an example of a second support member that is smaller in size than the first support member is disposed. In addition, the toner cartridges 70m and 70c as examples of third and fourth toner cartridges that are smaller in size than the first toner cartridge can be attached/detached to/from the rotary main body 90. In accordance with this, in the rotary main body 90, the trays 80m and 80c that are examples of third and fourth support members that are smaller in size than the first support member are disposed.

Here, rotation driving of the rotary main body 90 will be described with reference to FIG. 5. As illustrated in FIG. 5, disk gears 92L and 92R are formed at both ends of the rotary main body 90. In addition, rotary drive gears 93L and 93R are connected to both ends of an oscillation shaft 91 to be able to perform drive transmission. Here, a driving force of the motor M1 is transmitted to the rotary drive gear 93R by a drive transmission mechanism. Next, driving forces are transmitted to the disk gears 92L and 92R by the rotary drive gears 93L and 93R, whereby the rotary main body 90 is driven to rotate. The rotary main body 90 rotates around the rotation axis 90C clockwise in FIG. 1.

The rotary main body 90 is supported to be able to oscillate around the oscillation shaft 91. The rotary main body 90 is biased in a counterclockwise direction in FIGS. 4A and 4B around the oscillation shaft 91 by a bias member not illustrated in the drawing. This direction can be regarded as a direction in which each of the developing rollers 51y to 51k approaches the photosensitive drum 2. As a result, in a state in which the rotary main body 90 is taking the development posture, each of the developing rollers 51y to 51k is brought into contact with the photosensitive drum 2.

Meanwhile, as illustrated in FIG. 5, rotary cams 90eL and 90eR are provided at both ends of the rotary main body 90. When the rotary main body 90 rotates clockwise in FIGS. 4A and 4B around the rotation axis 90C, the rotary cams 90eL and 90eR are brought into contact with a roller 96 (FIGS. 4A and 4B) supported on the frame 16. Then, the rotary main body 90 moves in a clockwise direction in FIGS. 4A and 4B with the oscillation shaft 91 used as its center. This direction can be regarded as a direction in which each of the developing rollers 51y to 51k moves away from the photosensitive drum 2. In addition, this direction can be regarded as a direction in which the rotary main body 90 approaches the opening 16a of the frame 16 and the door 14.

In accordance with this, when the rotary main body 90 rotates and switches from the development posture to the replacement posture, the rotary main body 90 oscillates around the oscillation shaft 91. In a state in which the rotary main body 90 is taking the replacement posture, the developing roller 51 is separated from the photosensitive drum 2.

As illustrated in FIG. 4B, in the black replacement posture, the toner cartridge 70k stops at a position facing the opening 16a and the door 14 arranged on the side surface 16b of the apparatus main body 1A. From this state, when the tray 80k is slid from a mounting position for the developing unit 50k to the outside of the rotary main body 90, a user can replace the toner cartridge 70k.

### Toner Cartridge Replacement Operation

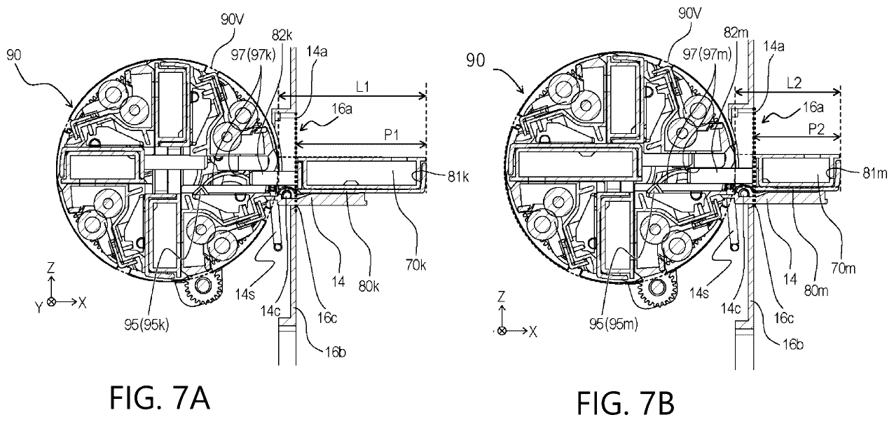

A toner cartridge replacement operation will be described with reference to FIGS. 4A, 6A to 6C, 7A, and 7B. FIGS. 6A to 6C are external views of the apparatus main body 1A. FIGS. 7A and 7B are cross-sectional views of the periphery of the rotary main body 90 at the time of replacement of the toner cartridge. FIGS. 7A and 7B are cross-sectional views of the apparatus in a virtual plane perpendicular to the rotation axis 90C of the rotary main body 90.

FIG. 6A illustrates the external appearance of the apparatus main body 1A during an image forming operation and in a standby state. “During an image forming operation” is during an execution period of a series of operations of the image forming apparatus 1 from feeding a sheet S to form an image on the sheet S and thereafter discharging the resultant sheet as a result. The standby state is a state in which the image forming apparatus 1 can start an image forming operation in a case in which an image formation instruction (print instruction) is received and is a state of waiting for an image formation instruction from a user. As illustrated in FIG. 6A, during an image forming operation and in the standby state, the door 14 is assumed to be in a closed state.

FIG. 6B illustrates an external appearance of the apparatus main body 1A at the time of replacement of a toner cartridge. At the time of replacement of a toner cartridge, the door 14 is assumed to be in an open state, and the tray 80 and the toner cartridge 70 are moved to the outside of the apparatus main body 1A.

The toner cartridge 70 can be moved to a mounting position and a retraction position retracted from the mounting position with respect to the developing frame 53 of the developing unit 50. In a state in which the toner cartridge 70 is at the mounting position with respect to the developing frame 53, as illustrated in FIG. 3, the discharge opening 71b and the reception opening 53b face each other. As illustrated in FIGS. 4A and 4B, the rotary main body 90 is configured to rotate around the rotation axis 90C and take the development posture or the replacement posture in a state in which the toner cartridge 70 is at the mounting position.

The toner cartridge replacement operation will now be described. First, a user instructs the control unit 330 of the apparatus main body 1A to perform a toner cartridge replacement operation. An instruction for the toner cartridge replacement operation, for example, is given using input via an operation panel (an operation unit) disposed in the apparatus main body 1A.

When the control unit 330 receives an instruction for a toner cartridge replacement operation, the rotary main body 90 rotates to the replacement posture of the toner cartridge 70 that is a replacement target (the toner cartridge 70 that has run out of toner) and stops. In other words, the control unit 330 rotates the rotary main body 90 to the replacement posture of the toner cartridge designated in the instruction for the toner cartridge replacement operation (in FIG. 4B, the black replacement posture for replacing the black toner cartridge 70k). In the replacement posture, the tray 80 supporting the toner cartridge 70 that is instructed to be replaced faces the opening 16a of the frame 16 of the apparatus main body 1A.

For example, the rotary main body 90 illustrated in FIG. 4A is in the yellow development posture in which the yellow developing roller 51y faces the photosensitive drum 2. At this time, the black toner cartridge 70k and the tray 80k may not face the opening 16a and the door 14. In other words, a toner cartridge 70 and the tray 80, in a case in which the rotary main body 90 is in a replacement posture or a development posture other than the replacement posture of this toner cartridge, may not face the opening 16a and the door 14. For this reason, the opening 16a may have a size allowing each toner cartridge 70 to individually pass through it. When the rotary main body 90 rotates clockwise in the drawing by a predetermined angle from the yellow development posture, as illustrated in FIG. 4B, the black toner cartridge 70k and the tray 80k face the opening 16a and the door 14.

Here, “the tray 80 faces the opening 16a” represents that the tray 80 is positioned to be able to move to the outside of the apparatus main body 1A through the opening 16a. In other words, in a case in which a tray 80 faces the opening 16a, in accordance with this tray 80 being moved to the outside of the rotary main body 90 in the direction of the radius of rotation by a movement mechanism to be described below, this tray 80 and the toner cartridge 70 supported on this tray 80 can protrude to the outside of the apparatus main body 1A. In FIG. 4A, none of the trays 80y to 80k face the opening 16a. In FIG. 4B, only the black tray 80k faces the opening 16a, and the other trays 80y to 80c do not face the opening 16a.

When the rotary main body 90 is positioned in the replacement posture, the tray 80 supporting the toner cartridge 70 that is a replacement target is moved toward the outside of the apparatus main body 1A by the motor M2.

In accordance with this, the toner cartridge 70 that is a replacement target moves from the mounting position to the retraction position with respect to the rotary main body 90. As illustrated in FIGS. 6B, 6C, 7A, and 7B, a tray 80 and the toner cartridge 70, which is a replacement target, supported by the tray 80 protrude to the outside of the apparatus main body 1A through the opening 16a.

More specifically, the tray 80 can be moved to an accommodating position and a detachment position with respect to the rotary main body 90. The accommodating position is a position at which the tray 80 is housed inside of the rotary main body 90. The detachment position is a position at which the tray 80 protrudes to the outside of the rotary main body 90 and the toner cartridge 70 can be taken out from the tray 80 (a detachment position; a replaceable position). Examples of the accommodating position are the positions of each tray 80y to 80k illustrated in FIGS. 4A and 4B. Examples of the detachment position are positions of the tray 80 illustrated in FIGS. 6B and 6C, the tray 80k illustrated in FIG. 7A, and the tray 80m illustrated in FIG. 7B.

When the tray 80 is located at the accommodating position, the toner cartridge 70 attached to the tray 80 is at the mounting position. When the tray 80 is at the detachment position, the toner cartridge 70 attached at the tray 80 is positioned at the retraction position.

Here, as illustrated in FIGS. 7A and 7B, the rotary main body 90 has a convex portion 95 that is used for holding the tray 80 at the accommodating position and holding the toner cartridge 70 at the mounting position. As illustrated in FIG. 8, a concave portion 87 fitted into the convex portion 95 is provided in the tray 80. Although FIGS. 7A and 7B illustrate convex parts 95k and 95m respectively corresponding to the trays 80k and 80m, and FIG. 8 illustrates concave parts 87y and 87m of the trays 80y and 80m, the convex portion 95 and the concave portion 87 are provided for each of the trays 80y to 80k. It is preferable that the convex portion 95 be biased in a direction for engagement with the concave portion 87.

By causing the convex portion 95 to fit into the concave portion 87 of the tray 80, the tray 80 is locked into the rotary frame 90f. In accordance with this, even when the rotary main body 90 rotates, the tray 80 stays at the accommodating position, and the toner cartridge 70 is prevented from moving from the mounting position. In a case in which the tray 80 is moved between the accommodating position and the detachment position by a movement device to be described below, the convex portion 95 is moved by the tray 80, and the convex portion 95 can be configured to deviate from the concave portion 87.

In this example, the door 14 is supported to be rotatable with respect to the apparatus main body 1A. As illustrated in FIG. 7A, the door 14 is biased from the open position to the closed position by the spring 14s. The spring 14s is, for example, a tensile spring and biases the door 14 to generate a moment around a support shaft 14c of the door 14 in a counterclockwise direction in FIGS. 7A and 7B.

The tray 80 presses the door 14, whereby the door 14 comes into the open state (the state illustrated in FIG. 6B). This state can be regarded also as a state in which the tray 80 is supported by the door 14. At least a portion of the tray 80 protruding to the outside of the apparatus main body 1A is supported by the door 14, whereby the toner cartridge 70 can be supported more stably. In other words, when the first toner cartridge (the toner cartridge 70k) is at a first retraction position, the opening/closing member (the door 14) that is present at the open position supports the first support member (the tray 80k). In addition, when the second toner cartridge (the toner cartridges 70y to 70c) is at a second retraction position, the opening/closing member (the door 14) that is at the open position supports a second support member (the trays 80y to 80c).

The door 14 is configured to be brought into contact with a portion of the frame 16 of the apparatus main body 1A (for example, a lower edge 16c of the opening 16a) at the open position and not to rotate downward beyond the open position. When the tray 80 is pulled back inside from outside of the apparatus main body 1A, the door 14 returns to the closed position in accordance with the biasing force of the spring 14s.

The toner cartridge 70 is removably held in the tray 80. For this reason, as illustrated in FIG. 6C, a user can remove the toner cartridge 70 from the tray 80 and perform an attachment operation (a replacement operation) of a new toner cartridge 70. In addition, in a case in which a plurality of toner cartridges 70 are to be replaced, by repeating the operation described above, the replacement operation can be performed.

FIGS. 7A and 7B illustrate cross-sections of the periphery of the rotary main body 90 at the time of replacing a toner cartridge. FIG. 7A illustrates a state at the time of replacing the black toner cartridge 70k. FIG. 7B illustrates a state at the time of replacing the magenta toner cartridge 70m.

The image forming apparatus 1 includes a movement device 85 (FIG. 8) that moves the toner cartridge 70 from a mounting position to a retraction position. In this example, the movement device 85 can be regarded to include the tray 80. The movement device 85k including the tray 80k can be regarded as an example of a first movement device including a first support member. The movement device 85m including the tray 80m can be regarded as an example of a second movement device including a second support member.

Also in a state in which the toner cartridge 70 at the retraction position, the tray 80 is in the state of being connected to the rotary main body 90 (a state of being supported by the rotary main body 90). In order to allow the operation of removing the toner cartridge 70 from the rotary main body 90 to be easily performed, it is preferable that the length of the toner cartridge 70 protruding from the rotary main body 90 at the retraction position should be long. Since the toner cartridge 70 is configured to be able to be removably installed in the rotary main body 90 through the tray 80, also in a case in which the length of the toner cartridge 70 protruding from the rotary main body 90 is long, the toner cartridge 70 can be stably supported by the tray 80.

A movement direction of the toner cartridge 70 when the toner cartridge 70 moves from the mounting position to the retraction position will be referred to as a retraction direction. In this example, the retraction direction of the toner cartridge 70 is a direction that intersects the direction of the rotation axis 90C (Y direction). Therefore, as illustrated in FIGS. 7A and 7B, when viewed in the direction of the rotation axis 90C (Y direction), the retraction direction of the toner cartridge 70 is a direction that is orthogonal to the direction of the rotation axis 90C (Y direction). The retraction direction of the toner cartridge 70 can be regarded as an outward direction (a direction away from the rotation axis 90C) in the direction of the radius of rotation of the rotary main body 90.

As illustrated in FIGS. 7A and 7B, since a user performs a detachment operation of the toner cartridge 70 from the rotary main body 90, when the toner cartridge 70 is to be detached, it is preferable that at least a portion of the toner cartridge 70 should protrude from the rotary main body 90. In this example, when the toner cartridge 70 is at the retraction position, the entire toner cartridge 70 protrudes from the rotary main body 90.

When the rotary main body 90 rotates around the rotation axis 90C, the locus of rotation of the rotary main body 90 can be regarded to coincide with a circumscribed circle of the rotary main body 90 (a virtual circle 90V denoted by broken lines in FIGS. 7A and 7B) having the rotation axis 90C as its center. When the toner cartridge 70 is at the retraction position, it is preferable that at least a half of the length of the toner cartridge 70 in the retraction direction should be outside of the locus of rotation of the rotary main body 90. In other words, when viewed in the direction of the rotation axis of the rotary, in the state in which the toner cartridge is at the retraction position, it is preferable that at least a half of the total length of the toner cartridge be located outside of the locus of rotation of the rotary in the movement direction of the toner cartridge from the mounting position to the retraction position. This can be applied to each toner cartridge 70 including the toner cartridge 70k as an example of the first cartridge and the toner cartridge 70m as an example of the second cartridge. In this example, as illustrated in FIGS. 7A and 7B, when the toner cartridge 70 is at the retraction position, the entire toner cartridge 70 is located outside of the locus of rotation of the rotary main body 90 (the virtual circle 90V).

Furthermore, in order to allow a user to easily grasp the toner cartridge 70, it is preferable that at least a portion of the toner cartridge 70 should be outside of the image forming apparatus 1 (outside of the apparatus main body 1A) when the toner cartridge 70 is at the retraction position. Here, outside of the apparatus means a space outside of the image forming apparatus 1 (outside of the apparatus main body 1A) when the image forming apparatus 1 is used, for example, in an image forming operation for a sheet S or the like.

In this example, an exterior surface of the apparatus main body 1A is formed by an exterior surface of the frame 16. In other words, the outside of the apparatus can also be regarded as the outside of the frame 16. Thus, the state in which at least a portion of the toner cartridge 70 is located outside of the apparatus can also be regarded as a state in which at least a portion of the toner cartridge 70 protrudes from the opening 16a of the frame 16 of the apparatus main body 1A toward the outside of the frame 16.

In this example, when the door 14 is at the closed position, the opening 16a of the frame 16 of the apparatus main body 1A is covered with the door 14. A portion of the exterior surface of the apparatus main body 1A is formed using the exterior surface 14a of the door 14 that is at the closed position. In this case, the outside of the apparatus means outside of the exterior surface 14a of the door 14 that is at the closed position. In other words, if the position of the exterior surface 14a of the door 14 that is at the closed position is set as an exterior position, when the toner cartridge 70 is at the retraction position, at least a portion of the toner cartridge 70 is located outside of the apparatus main body 1A from this exterior position.

In other words, at least a portion of the toner cartridge 70 is located in a space that is outside of the apparatus main body 1A if the door 14 is at the closed position. Then, in the retraction direction of the toner cartridge 70, at least a portion of the toner cartridge 70 is located on the downstream side of the exterior position.

When the toner cartridge 70 is at the retraction position with a side surface 16b on which the opening 16a is formed as a front surface of the apparatus main body 1A, at least a portion of the toner cartridge 70 can be regarded to protrude to a front side from the exterior surface of the front side of the apparatus main body 1A. In this case, a user can easily perform a replacement operation of the toner cartridge 70 by accessing the toner cartridge 70 from the front side of the image forming apparatus.

When the toner cartridge 70 is at the retraction position, it is preferable that at least a half of the length of the toner cartridge 70 in the retraction direction should be outside of the apparatus. In other words, when viewed in the direction of the rotation axis of the rotary, in a state in which the toner cartridge is at the retraction position, it is preferable that at least a half of the total length of the toner cartridge be located outside of the main body frame in the movement direction of the toner cartridge moving from the mounting position toward the retraction position described above. This can be applied to each toner cartridge 70 including the toner cartridge 70k as an example of a first cartridge and the toner cartridge 70m as an example of a second cartridge. In addition, when the toner cartridge 70 is at the retraction position, it is more preferable that the entire toner cartridge 70 is located outside of the apparatus. In this example, although the exterior surface of the front side of the apparatus main body 1A is formed using the exterior surface 14a of the door 14 and the side surface 16b, the configuration of the door 14 is not limited thereto. For example, the size of the door 14 may be a size required for covering the entire side surface 16b. In this case, the exterior surface of the front side of the apparatus main body 1A is formed using the exterior surface 14a of the door 14.

The tray 80 includes a cartridge holding portion 81 (see FIGS. 6C and 8) that holds the toner cartridge 70. The cartridge holding portion 81 is a portion in which the toner cartridge 70 is mounted. When the tray 80 is at the detachment position, it is preferable that the entire cartridge holding portion 81 should be located outside of the locus of rotation of the rotary main body 90 in the retraction direction. When the tray 80 is at the detachment position, it is preferable that at least a half of the length of cartridge holding portion 81 should be located outside of the apparatus in the retraction direction.

Here, as described above, the toner cartridge 70k and the tray 80k are larger in size than the other toner cartridges 70y to 70c and trays 80y to 80c. For this reason, as illustrated in FIGS. 7A and 7B, in this example, the amount of movement of the tray 80 at the time of replacing the toner cartridge is changed in accordance with the size of the toner cartridge 70.

More specifically, as illustrated in FIG. 7A, when the tray 80k (a first support member) moves from an accommodating position (first accommodating position) to a detachment position (first detachment position), a movement distance is L1. When the tray 80m (a second support member) moves from the accommodating position to the detachment position (a third detachment position), the movement distance is L2. In FIG. 7B, while a state in which the toner cartridge 70m and the tray 80m have been moved is illustrated, a movement distance is also L2 when the trays 80y and 80c move from the accommodating position to the detachment position. In this case, L1 is larger than L2. In other words, the movement distance of the first support member when the first toner cartridge moves from the first mounting position to the first retraction position can be regarded to be longer than the movement distance of the second support member when the second toner cartridge moves from the second mounting position to the second retraction position.

As illustrated in FIG. 7A, in a state in which the tray 80k is at the detachment position, and the toner cartridge 70k is at the retraction position, the toner cartridge 70k protrudes outside of the apparatus from the exterior surface of the apparatus main body 1A by a distance P1. In this example, the tray 80k also protrudes outside of the apparatus from the exterior surface of the apparatus main body 1A by the distance P1.

As illustrated in FIG. 7B, in a state in which the tray 80m is at the detachment position, and the toner cartridge 70m is at the retraction position, the toner cartridge 70m protrudes outside of the apparatus from the exterior surface of the apparatus main body 1A by a distance P2. In this example, the tray 80m also protrudes outside of the apparatus from the exterior surface of the apparatus main body 1A by the distance P2. The toner cartridges 70y and 70c also protrude outside of the apparatus from the exterior surface of the apparatus main body 1A by the distance P2.

The distance P1 described above is larger than the distance P2. In other words, a length of the first toner cartridge, which is at the first retraction position, protruding from the opening 16a of the apparatus main body 1A is a first length (P1), and a length of the second toner cartridge, which is at the second retraction position, protruding from the opening 16a is a second length (P2). In this case, the first length can be regarded to be longer than the second length.

For the toner cartridges 70y to 70c, which are smaller in size than toner cartridge 70k, it is preferable in terms of strength that the distance P2 that protrudes outside of the apparatus at the retraction position should be shorter than the distance P1 that the toner cartridge 70k protrudes outside of the apparatus at the retraction position. This is due to the following reasons. When the toner cartridge 70 is located at the retraction position, at least a portion of the toner cartridge 70 protrudes outside of the apparatus from the outside of the locus of rotation of the rotary main body 90 or the exterior surface of the apparatus main body 1A. At this time, the tray 80 supports the weight of the toner cartridge 70 in the state of being cantilevered on the rotary main body 90. For this reason, shortening the distance P2 by which the toner cartridge 70y to 70c protrude outside of the apparatus at the retraction position can reduce the load applied to the trays 80y to 80c and a guide portion 97 of the rotary main body 90 that supports the trays 80y to 80k. Since the toner cartridges 70y to 70c are smaller in size than the toner cartridges 70k, even if the distance P2 is shorter than the distance P1, the workability of replacement of cartridges for the tray 80y to 80c can be maintained.

### Tray Arrangement in Rotary

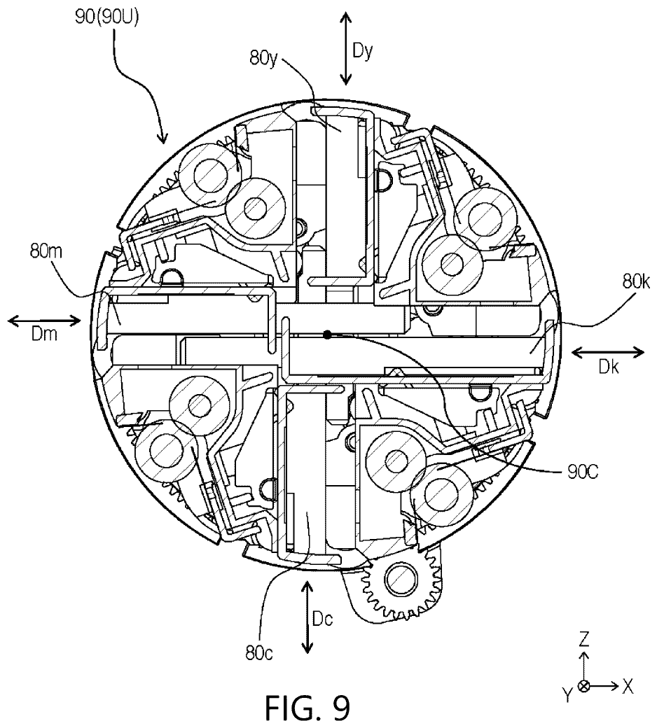

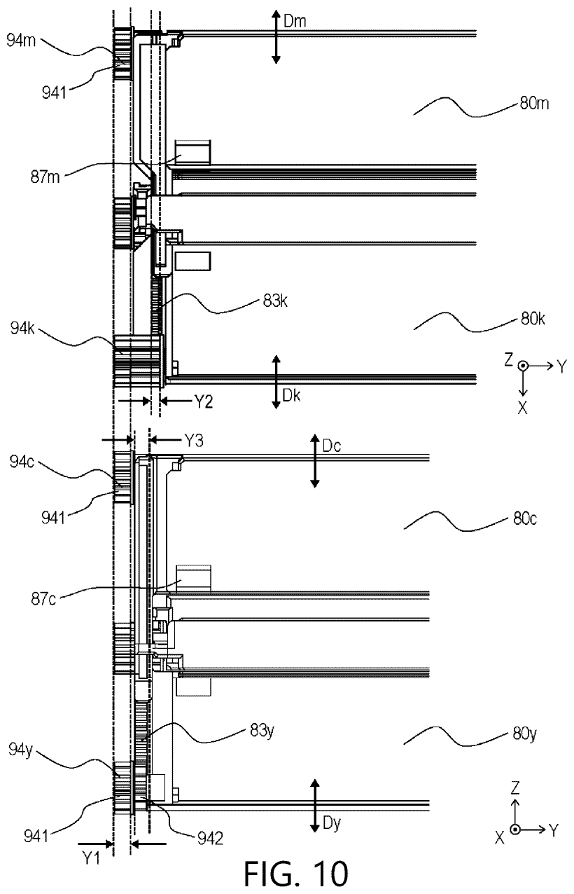

The arrangement of the trays 80y to 80k inside of the rotary main body 90 will be described with reference to FIGS. 8, 9, and 10. FIG. 8 is a perspective view illustrating the arrangement of the trays 80y to 80k inside of the rotary main body 90. FIG. 9 is a cross-sectional view illustrating the arrangement of the trays 80y to 80k inside of the rotary main body 90. FIG. 10 is a diagram illustrating the component arrangement of the trays 80y to 80k at one end in the Y direction. FIG. 9 illustrates a cut face of the rotary main body 90 in a virtual plane perpendicular to the rotation axis 90C of the rotary main body 90. An upper half portion of FIG. 10 is a diagram in which the rotary main body 90 and the trays 80m and 80k illustrated in FIG. 8 are viewed from the upper right side (+Z side) of FIG. 8, and a lower half portion of FIG. 10 is a diagram in which the rotary main body 90 and the trays 80c and 80y illustrated in FIG. 8 are viewed from a left side (−X side) in FIG. 8.

As illustrated in FIG. 8, in the trays 80y to 80k, cartridge holding parts 81y to 81k and guided parts 82y to 82k are respectively disposed.

Toner cartridges 70y to 70k are respectively mounted in the cartridge holding parts 81y to 81k. The cartridge holding parts 81y to 81k respectively house at least parts of the toner cartridges 70y to 70k mounted therein.

The guided parts 82y to 82k are disposed at both ends of the trays 80y to 80k having the cartridge holding parts 81y to 81k interposed therebetween in the Y direction. The guided parts 82y to 82k are elongated members that extend in a direction orthogonal to the rotation axis of the rotary main body 90.

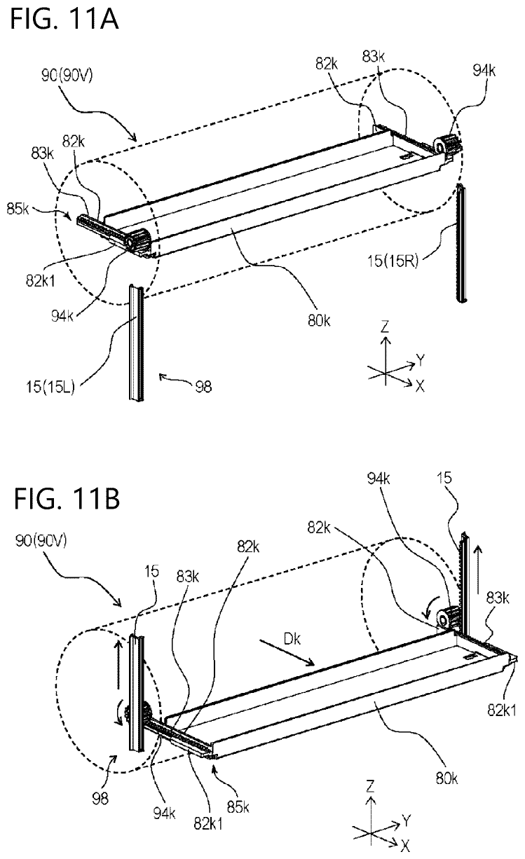

In this example, a reinforcing rib 82k1 is formed in a portion of the guided portion 82k in the movement direction Dk of the tray 80k, and a reinforcing rib 82ml is formed in a portion of the guided portion 82m in the movement direction Dm of the tray 80m (see also FIGS. 11A and 11B). The reinforcing ribs 82kl and 82 ml are in the form of ribs (protrusions) protruding outwardly in the Y direction from the guided parts 82k and 82m at both ends of the trays 80k and 80m in the Y direction and elongated in the movement directions Dk and Dm of the trays 80k and 80m. The reinforcing ribs 82kl and 82 ml increase the rigidity of the guided parts 82k and 82m.

In this example, although the length of reinforcing ribs 82ml and 82k1 is limited by avoiding the guided parts 82y and 82c, in a case in which interference with the guided parts 82y and 82c does not occur, the reinforcing ribs 82ml and 82kl may be provided over the entire length of the guided parts 82m and 82k. Reinforcing ribs may be added to the guided parts 82y and 82c. In a case in which the rigidity of the guided parts 82m and 82k is sufficient, a configuration in which the reinforcing ribs 82ml and 82k1 are not provided may be employed.

Rack parts 83y to 83k (rack gears) are formed in the guided parts 82y to 82k. Pinion gears 94y to 94k are rotatably held inside of the rotary main body 90. The pinion gears 94y to 94k are respectively engaged with the rack parts 83y to 83k to enable drive transmission.

The rack parts 83y to 83k and the pinion gears 94y to 94k are parts of the movement device 85y to 85k configured to move the toner cartridges 70y to 70k from the mounting position to the retraction position. The rack parts 83y to 83k and the pinion gears 94y to 94k can be regarded as a portion of a driven device driven by the drive device 98 of the apparatus main body 1A. The pinion gears 94y to 94k can be regarded as rotation bodies (rotation members) that move the trays 80y to 80k with respect to the rotary main body 90 through rotation.

The pinion gears 94y to 94k and the rack parts 83y to 83k function as driven parts for the movement devices 85y to 85k of the rotary main body 90 to receive a driving force from the drive device 98 of the apparatus main body 1A. The pinion gear 94k and the rack portion 83k are examples of a first pinion gear and a first rack gear that constitute at least a portion of the first driven portion included in the first movement device. The pinion gear 94m and the rack portion 83m are examples of a second pinion gear and a second rack gear that constitute at least a portion of the second driven portion included in the second movement device.

The rotary main body 90 has guide portions 97 (see FIGS. 7A and 7B) that are engaged with the guided parts 82y to 82k. FIG. 7A illustrates the guide portion 97 (97k) that is engaged with the guided portion 82k of the tray 80k, and FIG. 7B illustrates a guide portion 97 (97m) that is engaged with the guided portion 82m of the tray 80m. In the rotary main body 90, similar guide portions that are respectively engaged with the guided parts 82y and 82c of the trays 80y and 80c are provided. In FIGS. 7A and 7B, while the guide portion 97 provided on one side (+Y side) of the rotary main body 90 in the Y direction is illustrated, a similar guide portion 97 is also provided on the other side (−Y side) of the rotary main body 90 in the Y direction.

As the tray 80 moves between the accommodating position and the detachment position, in at least a portion of the movement range, the guide portion 97 maintains the state of being engaged with the guided portion 82 and guides the movement direction of the tray 80. In this example, the guide portion 97 maintains the state of being engaged with the guided portion 82k in the entire range of movement of the tray 80k between the accommodating position and the detachment position. In this example, the guide portion 97 maintains the state of being engaged with the guided portion 82m in the entire range of movement between the accommodating position and the detachment position of the tray 80m.

As illustrated in FIGS. 8 and 9, as described below more specifically, four trays 80y to 80k are arranged to overlap each other inside of the rotary main body 90.

When the pinion gears 94y to 94k rotate, the rack parts 83y to 83k and the trays 80y to 80k move with respect to the rotary main body 90. As illustrated in FIG. 9, the four trays 80y to 80k are arranged such that the directions of movement of the four trays 80y to 80k are directions each rotated by 90 degrees with respect to the rotary main body 90. For this reason, the tray 80y and tray 80c, and the tray 80m and the tray 80k are respectively held to be able to slide and move in a substantially same direction (parallel direction). The movement direction of each of the trays 80y to 80k at the time of sliding movement is regulated by the above-described engagement between the guided parts 82y to 82k and the guide portion 97.

The trays 80y to 80k move to the outside of the apparatus through the opening 16a. When each of the trays 80y to 80k moves from the opening 16a to the outside of the apparatus, the movement direction of each tray is substantially the same direction (parallel).

As illustrated in FIG. 9, in the movement direction Dk of the tray 80k, a range in which the tray 80k is disposed is disposed to overlap a range in which the tray 80y is disposed and a range in which the tray 80c is disposed. In the movement direction Dk of the tray 80k, a range in which the tray 80k is disposed to overlap the rotation axis 90C of the rotary main body 90. In other words, the toner cartridge 70k held in the cartridge holding portion 81k of the tray 80k can be regarded to overlap the rotation axis 90C of the rotary main body 90 (FIG. 4B).

On the other hand, in the movement direction Dm of the tray 80m, a range in which the tray 80m is disposed is displaced such that that it does not overlap a range in which the tray 80y is disposed and a range in which the tray 80c is disposed. Furthermore, in the movement direction Dy of the tray 80y, a range in which the tray 80y is disposed is displaced such that it does not overlap the range in which the tray 80m is disposed and the range in which the tray 80k is disposed. Similarly, in the movement direction Dc of the tray 80c, a range in which the tray 80c is disposed is displaced such that it does not overlap the range in which the tray 80m is disposed and the range in which the tray 80k is disposed.

A positional relation between the 80 trays can also be represented as follows. When viewed in the movement direction Dy of the tray 80y, the tray 80y and the tray 80k overlap each other, but the tray 80y and the tray 80m do not overlap each other.

When viewed in the movement direction Dm of the tray 80m, the tray 80m and the tray 80k overlap each other, but the tray 80m and the trays 80y and 80c do not overlap each other. When viewed in the movement direction Dc of the tray 80c, the tray 80c and the tray 80k overlap each other, but the tray 80c and the tray 80m do not overlap each other.

Here, the overlapping of two elements (components, parts, units, or the like) when viewed in a specific direction represents that, in a case in which the elements are vertically projected onto a virtual plane that is perpendicular to this direction, a projection area of one element and a projection area of the other element overlap each other at least in a part.

As illustrated in FIGS. 8 and 10, the range in which the rack portion 83m and the guided portion 82m are disposed and the range in which the rack portion 83k and the guided portion 82k are disposed overlap each other at least in a portion in the direction of the rotation axis 90C of the rotary (Y direction). In other words, in this example, the range in which the first rack gear (the rack portion 83k) is disposed and the range in which the second rack gear (the rack portion 83m) is disposed can be regarded to overlap each other in at least a portion in the direction of the rotation axis (Y direction). Thus, compared to an arrangement in which the rack portion 83m and the guided portion 82m, and the rack portion 83k and the guided portion 82k do not overlap each other, the rack parts 83m and 83k and the guided parts 82m and 82k can be arranged to save the space in the Y direction.

In the direction of the rotation axis 90C (Y direction), the range in which the rack portion 83y and the guided portion 82y are disposed and the range in which the rack portion 83c and the guided portion 82c are disposed overlap each other at least in a part. In other words, in this example, the range in which a third rack gear (the rack portion 83y) is disposed and the range in which a fourth rack gear (the rack portion 83c) is disposed overlap each other at least in a portion in direction of the rotation axis of the rotary (Y direction). Thus, compared to an arrangement in which the rack portion 83y and the guided portion 82y, and the rack portion 83c and guided portion 82c do not overlap each other, the rack parts 83y, and 83c and the guided parts 82y and 82c can be arranged to save the space in the Y direction.

Here, an engagement position between the rack portion 83 and the pinion gear 94 will be described with reference to FIG. 10. An upper half portion of FIG. 10 illustrates an engagement position between the rack portion 83k and the pinion gear 94k. A lower half portion of FIG. 10 illustrates an engagement position between the rack portion 83y and the pinion gear 94y.

In the direction of the rotation axis 90C of the rotary main body 90 (Y direction), in an area Y1 in the drawing, a driving force transmitted from the motor M2 (FIG. 2) as a drive source by a transmission device to be described below is transmitted to the pinion gears 94y to 94k. In an area Y3 in the drawing in the Y direction, the pinion gear 94k is engaged with the rack portion 83k to be able to perform drive transmission. In an area Y2 in the drawing in the Y direction, the pinion gear 94y is engaged with the rack portion 83y to be able to perform drive transmission. In addition, similar to the rack portion 83k, the rack portion 83m is engaged with the pinion gear 94m (FIG. 8) in the area Y2 to be able to perform drive transmission. Similar to the rack portion 83y, the rack portion 83c is engaged with the pinion gear 94c (FIG. 8) in the area Y3 to be able to perform drive transmission.

Here, the areas Y2 and Y3 are at different positions in the Y direction (displaced in the Y direction). The area Y1 is located at a position different in the Y direction from any one of the areas Y2 and area Y3. In other words, the area Y1 is displaced in the Y direction from the areas Y2 and Y3.

Furthermore, in a state in which the toner cartridges 70y and 70c are at the mounting positions, the range in which the rack portion 83y is disposed and the range in which the rack portion 83c is disposed overlap each other at least in a portion in the movement direction of the rack portion 83y (the movement direction Dy of the tray 80y). Since the movement directions Dy and Dc of the trays 80y and 80c are substantially the same (parallel) directions in this example, also in the movement direction Dc of the tray 80c, the range in which the rack portion 83y is disposed and the range in which the rack portion 83c is disposed overlap each other at least in a part. Thus, in a state in which the toner cartridges 70y and 70c are at the mounting positions, a tooth face of the rack portion 83y and a tooth face of the rack portion 83c face each other in a direction orthogonal to the movement directions Dy and Dc of the rack parts 83y and 83c (a horizontal direction in FIG. 8).

Furthermore, in a state in which the toner cartridges 70m and 70k are at the mounting positions, the range in which the rack portion 83m is disposed and the range in which the rack portion 83k is disposed overlap each other at least in a portion in the movement direction of the rack portion 83m (the movement direction Dm of the tray 80m). Since the movement directions Dm and Dk of the trays 80m and 80k are substantially the same directions (parallel) in this example, also in the movement direction Dk of the tray 80k, the range in which the rack portion 83m is disposed and the range in which the rack portion 83k is disposed overlap each other at least in a part. Thus, in a state in which the toner cartridges 70m and 70k are at the mounting positions, a tooth face of the rack portion 83m and a tooth face of the rack portion 83k face each other in a direction orthogonal to the movement directions Dm and Dk of the rack parts 83m and 83k (a vertical direction in FIG. 8).

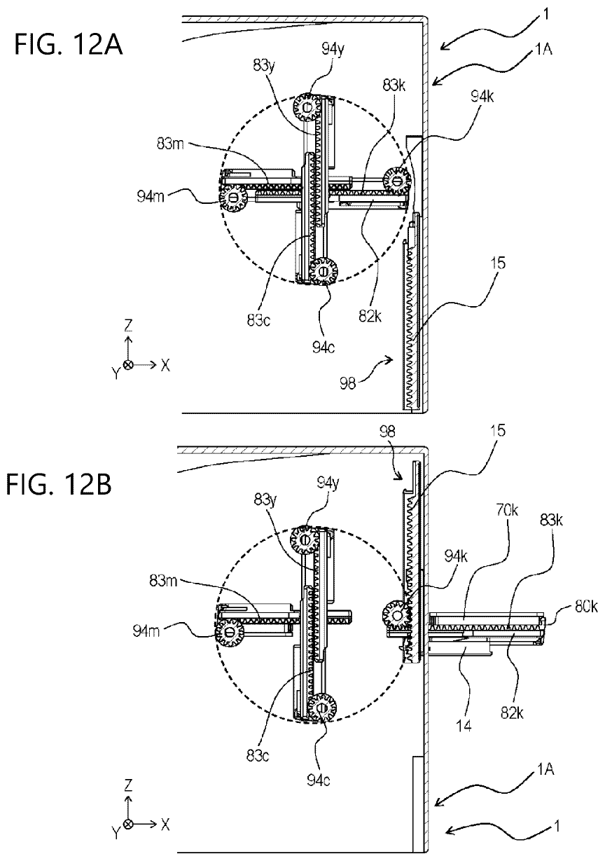

As illustrated also in FIG. 12A to be described below, when viewed in the direction of the rotation axis 90C (Y direction), the rack portion 83y overlaps the rack portion 83m and the rack portion 83k. When viewed in the direction of the rotation axis 90C (Y direction), the rack portion 83m overlaps the rack portion 83y and the rack portion 83c. When viewed in the direction of the rotation axis 90C (Y direction), the rack portion 83c overlaps the rack portion 83m and the rack portion 83k. When viewed in the direction of the rotation axis 90C (Y direction), the rack portion 83k overlaps the rack portion 83y and the rack portion 83c. In other words, in the direction of the rotation axis of the rotary (Y direction), the range in which the first rack gear (the rack portion 83k) is disposed and the range in which the second rack gear (the rack portion 83y) is disposed can be regarded not to overlap each other. In addition, when viewed in the direction of the rotation axis of the rotary (Y direction), the first rack gear (the rack portion 83k) and the second rack gear (the rack portion 83y) can be regarded to overlap each other in a state in which the first toner cartridge 70k is at the first mounting position, and the second toner cartridge 70y is at the second mounting position.

In this way, since the positions at which the rack parts 83k and 83m are disposed and the positions at which the rack parts 83y and 83c are disposed are different from each other in the Y direction, the rack parts 83y and 83c and the rack parts 83m and 83k can be disposed to overlap each other when seen in the Y direction.

In accordance with this, space saving of the arrangement of the four trays inside of the rotary main body 90 is performed, and downsizing of the rotary main body 90 in the direction of the radius of rotation can be realized. In other words, if the rack parts 83 are disposed not to overlap each other when viewed in the Y direction while the movement distances of the trays 80y to 80k to be equivalent to those of this example, an area required to arrange the four rack parts when viewed in the Y direction becomes large. Compared to this configuration, by arranging the positions of a plurality of rack parts 83 in the Y direction to deviate from each other and overlapping the rack parts 83 when viewed in the Y direction, the area of arrangement of the rack parts 83 when seen in the Y direction can be decreased.

In this example, the four rack parts 83y to 83k are arranged in two pairs of two racks with positions thereof deviating in the Y direction. In other words, in the direction of the rotation axis of the rotary (Y direction), the ranges in which the first rack gear and the second rack gear are disposed can be regarded to overlap each other, and the ranges in which the third rack gear and the fourth rack gear are disposed can be regarded to overlap each other. In addition, the range in which the first rack gear and the second rack gear are disposed and the range in which the third rack gear and the fourth rack gear are disposed can be regarded to be disposed not to overlap each other in the Y direction. In accordance with this, compared to a case in which the positions of four rack parts 83y to 83k are arranged to deviate from each other in the Y direction, downsizing of the rotary main body 90 in the Y direction can be achieved.

### Movement Configuration of Tray

A configuration relating to movement of the trays 80y to 80k disposed inside of the rotary main body 90 will be described with reference to FIGS. 11A, 11B, 12A, and 12B. FIGS. 11A and 11B are perspective views illustrating a configuration relating to movement of the tray 80k. FIGS. 12A and 12B are cross-sectional views illustrating the configuration relating to the movement of the tray 80k.

In this example, all the trays 80y to 80k are driven in accordance with a driving force of the motor M2 being transmitted to the pinion gears 94y to 94k by the drive racks 15L and 15R as transmission devices. Here, a configuration for moving the tray 80k with respect to the rotary main body 90 will be described, and configurations for moving the trays 80y to 80c with respect to the rotary main body 90 are substantially the same as the configuration for moving the tray 80k, and thus description thereof will be omitted.

FIG. 11A illustrates a state in which the tray 80k is inside of the rotary main body 90 (that is, a state in which the toner cartridge 70k is mounted in the developing unit 50k). In other words, FIG. 11A illustrates a state in which the tray 80k is at the accommodating position and corresponds to a state in which the toner cartridge 70k is at the mounting position with respect to the developing frame 53k (FIG. 4A). FIG. 11B illustrates the state in which the tray 80k has been slid out of the rotary main body 90. In other words, FIG. 11B illustrates a state in which the tray 80k is at the detachment position and corresponds to a state in which the toner cartridge 70k is at the retraction position with respect to the developing frame 53k (FIG. 4B).

The apparatus main body 1A according to this example has drive racks 15L and 15R as drive gears that drive a pinion gear 94. Each drive rack 15 is driven by the motor M2 through a drive transmission mechanism not illustrated in the drawing.

As described above, two rack parts 83k are formed at both ends of the tray 80k in the Y direction. Two pinion gears 94k and two drive racks 15L and 15R are arranged at positions corresponding to the rack parts 83k at both ends. In other words, the apparatus main body 1A according to this example has the drive racks 15L and 15R as a first drive gear and a second drive gear. The drive rack 15L can be regarded as an example of the first drive gear, and the drive rack 15R can be regarded as an example of the second drive gear.

Such number assignment is used for the convenience of description and can be interchanged as appropriate in principle. When it is not necessary to distinguish between the drive racks 15L and 15R, each thereof will be denoted as “drive rack 15”.

The rack parts 83 according to this example are configured as a rack gear pair, and the pinion gears 94 according to this example are configured as a pinion gear pair. In this example, although the rack gear pair and the pinion gear pair are disposed on one-end side and the other-end side of the support member (the tray 80) in the Y direction, they may be arranged at other positions. The rack parts 83k and the pinion gears 94k of the movement device 85k corresponding to the tray 80k can be respectively regarded as examples of a first rack gear pair and a first pinion gear pair.

The rack parts 83y to 83c and the pinion gears 94y to 94c of the movement devices 85y to 85c corresponding to any one of the other trays 80y to 80c can be respectively regarded as examples of a second rack gear pair and a second pinion gear pair.

One of the rack gear pair is engaged with one of the pinion gear pair, and the other of the rack gear pair is engaged with the other of the pinion gear pair. At least one of the pinion gear pair is driven by the drive rack 15L as a first drive rack. In this example, both of the pinion gear pair are driven simultaneously by the drive racks 15L and 15R as the first drive rack and the second drive rack. In accordance with this, it becomes difficult for the rotation of the tray 80 to occur, and stable movement of the toner cartridge 70 can be achieved.

The tray 80 may be configured to have one rack portion 83 and be moved by one drive rack 15 through one pinion gear 94.

The tray 80k is held slidably movable in a direction parallel to the guided portion 82k (that is, the movement direction Dk) with respect to the rotary main body 90. The drive rack 15 is held slidably movable in a direction intersecting the movement direction Dk of the tray 80k with respect to the apparatus main body 1A. The drive rack 15 is configured to slidably move (reciprocate) with respect to the apparatus main body 1A in the first direction (upwardly in the vertical direction in this example) and in a second direction (downwardly in the vertical direction in this example) opposite to the first direction. In other words, the movement direction of the drive rack 15 according to this example is a direction that intersects (preferably, a direction orthogonal to) both the movement direction Dk of the tray 80k and the direction of the rotation axis 90C of the rotary main body 90 (Y direction).

A tray moving operation of sliding the tray 80k between the accommodating position and the detachment position will be described with reference to FIGS. 11A and 11B. The tray moving operation of the tray 80k is performed using the motor M2 (FIG. 2), a transmission unit 15t including a drive transmission mechanism, a drive rack 15, a pinion gear 94k and a rack portion 83k.

First, a tray moving operation (a tray pull-out operation) at the time of detaching the toner cartridge 70k from the rotary main body 90 will be described. In a state before start of the tray pull-out operation, the drive rack 15 is positioned below a position at which it is engaged with the pinion gear 94k (FIG. 11A). As described above, in the toner cartridge 70k replacing operation, the rotary main body 90 takes the replacement posture (FIG. 4B) of the toner cartridge 70k.

When the tray pull-out operation is started, the drive rack 15 is slid in an upward direction of the apparatus main body 1A by the driving force of the motor M2. The drive rack 15 is engaged with the pinion gear 94k in the process of moving, and the pinion gear 94k is driven to rotate.

As illustrated in FIG. 11B, as the pinion gear 94k is driven to rotate in the direction of an arrow in the drawing, a driving force is input to the rack portion 83k that is engaged with the pinion gear 94k. In accordance with this, the tray 80k is pushed out of the apparatus and moves from the accommodating position to the detachment position with respect to the rotary main body 90. The movement direction of the tray 80k at this time is guided in a predetermined movement direction Dk in accordance with the engagement between the guided portion 82k and the guide portion 97k (FIG. 7A) of the rotary main body 90. As a result of the tray 80k moving from the accommodating position to the detachment position, the toner cartridge 70k is moved from the mounting position to the retraction position with respect to the developing unit 50k.

In a state in which the tray 80k is located at the detachment position, and the toner cartridge 70k is located at the retraction position, a user can perform attachment/detachment of the toner cartridge 70k for the tray 80k.

A tray moving operation (a tray pull-in operation, a tray inserting operation) at the time of attaching the toner cartridge 70 to the rotary main body 90 is performed in a reverse process of the tray pull-out operation. For example, as a user operates a predetermined operation unit, the tray pull-in operation is started. When the tray pull-in operation is started, the drive rack 15 is slid to a downward direction of the apparatus main body 1A by the driving force of the motor M2. Here, the direction of rotation of the motor M2 in the tray pull-in operation is a direction opposite to that of the tray pull-out operation.

As the pinion gear 94k is driven to rotate in a direction opposite to that of the arrow illustrated in FIG. 11B, a driving force is input to the rack portion 83k that is engaged with the pinion gear 94k. In accordance with this, the tray 80k is pulled into the apparatus and moved from the detachment position to the accommodating position with respect to the rotary main body 90.

The movement direction of the tray 80k is guided in the movement direction Dk (a direction opposite to that of the arrow illustrated in FIG. 11B) in accordance with the engagement between the guided portion 82k and the guide portion 97k (FIG. 7A) of the rotary main body 90. As a result of the tray 80k moving from the detachment position to the accommodating position, the toner cartridge 70k is moved from the retraction position to the mounting position with respect to the developing unit 50k.

While the movement of the black tray 80k and the toner cartridge 70k has been described as above, the movement of the other trays 80y to 80c and the other toner cartridges 70y to 70c is also performed using a similar mechanism. In other words, in the replacement posture of each toner cartridge replacement position, the drive rack 15 transmits driving to the pinion gears 94y to 94c.

A drive device 98 for driving the movement device 85 disposed in the rotary main body 90 is constituted by the motor M2 disposed in the apparatus main body 1A and a transmission unit 15t that is a transmission device including drive racks 15 (15L and 15R) and drive transmission mechanism.

As described above, in this example, a plurality of movement devices 85k to 85y corresponding to a plurality of toner cartridges 70k to 70y are disposed in the rotary main body 90. The drive device 98 of the apparatus main body 1A is a common drive device that drives the plurality of movement devices 85k to 85y (a plurality of driven devices) of the rotary main body 90.

In this example, in accordance with the rotation of the rotary main body 90, the drive target of the drive device 98 is switched. In other words, the drive device according to this example includes a drive rack 15 as a transmission member that transmits the driving force of a drive source. The drive device can take a state in which the transmission member is engaged with the first driven portion (the pinion gear 94k) for drive transmission and a state in which the transmission member is engaged with the second driven portion (the pinion gear 94m) for drive transmission. In addition, the drive device can take a state in which the transmission member is detached from the first driven portion and the second driven part.

As described above, the pinion gears 94y to 94k are held in the rotary main body 90. Therefore, in order for the rotary main body 90 to rotate, it is preferable that the engagement between the pinion gears 94y to 94k and the drive rack 15 should be released.

FIG. 12A illustrates a state in which the tray 80k is inside of the rotary main body 90 (a state of being at the accommodating position). FIG. 12B illustrates a state in which the tray 80k has moved outside of the rotary main body 90 (a state in which it has moved to the detachment position).

As illustrated in FIG. 12A, when the tray 80k is inside of the rotary main body 90, the drive rack 15 is located in a lower portion inside of the apparatus main body 1A. At this time, the drive rack 15 is retracted from the pinion gear 94k. For this reason, the rotary main body 90 can be rotated without being obstructed by the drive rack 15. More specifically, the drive rack 15 can be retracted to the outside of the locus of rotation of the rotary main body 90 that is denoted by dotted lines in FIGS. 12A and 12B.

As described above, by driving the motor M2 in forward and reverse directions, the tray 80 attached to the rotary main body 90 can be moved from the mounting position to the accommodating position and from the detachment position to the accommodating position with respect to the rotary main body 90. In other words, the drive device according to this example can not only drive each movement device of the rotary such that the toner cartridge is moved from the mounting position to the retraction position but also drive each movement device such that the toner cartridge is moved from the retraction position to the mounting position.

Here, as described above, in this example, the amount of movement of the tray 80 at the time of replacing the toner cartridge is changed in accordance with the size of the toner cartridge 70. More specifically, as illustrated in FIGS. 7A and 7B, a movement distance L1 at the time of the black tray 80k moving from the accommodating position to the detachment position is longer than a movement distance L2 at the time of the other trays 80y to 80c moving from the accommodating position to the detachment position.

For this reason, in this example, when the toner cartridge 70y to 70k are moved from the mounting position to the retraction position, a value acquired by dividing the speed of the rack portion 83k by the speed of the drive rack 15 is larger than a value acquired by dividing the speed of the rack portion 83y to 83c by the speed of the drive rack 15.

For example, as illustrated in FIG. 10, the pinion gear 94y is configured as a stepped gear, and the pitch circle radius of a small diameter gear 942 that is engaged with the rack portion 83y is configured to be smaller than the pitch circle radius of a large diameter gear 941 that is engaged with the drive rack 15. The pinion gears 94m and 94c are configured as similar stepped gears. On the other hand, the pinion gear 94k is configured to have the same pitch circle radius in a portion that is engaged with the drive rack 15 and a portion that is engaged with the rack portion 83k. At this time, the pitch circle radius of pinion gear 94k can be configured to be the same as the pitch circle radius of the large diameter gears 941 of the pinion gears 94y to 94c. According to this configuration, even if the movement distances of the drive racks 15 are the same, the movement distance of the rack portion 83k can be configured to be larger than that of the other rack parts 83y to 83c. In other words, the movement distance L1 at the time of the black tray 80k moving from the accommodating position to the detachment position can be configured to be longer than the movement distance L2 at the time of the other trays 80y to 80c moving from the accommodating position to the detachment position.

By configuring the pinion gears 94y to 94c as stepped gears, while the pinion gears 94y to 94k are configured to receive a driving force from the same drive rack 15, the movement distance L1 of the tray 80k can be configured to be larger than the movement distance L2 of the other trays 80y to 80c.

Instead of (or in combination with) the configuration in which the pinion gears 94y to 94c are stepped gears, the pinion gear 94k may be configured as stepped gear. In such a case, a portion of the pinion gear 94k that is engaged with the drive rack 15 may be configured to be a small-diameter gear, and a portion of the pinion gear 94k that is engaged with the rack portion 83k may be configured to be a large-diameter gear having a pitch circle radius larger than that of the small-diameter gear. The stepped gear is an example of a reduction mechanism and may be replaced by a known reduction mechanism that reduces the amount of movement of components of the output side (the tray 80 side) to be less than the amount of movement of components of the input side (the drive source side).

In addition, the amount of movement of the drive rack 15 at the time of moving the toner cartridge 70k from the mounting position to the retraction position may be configured to be larger than the amount of movement of the drive rack 15 at the time of moving the toner cartridges 70y to 70c from the mounting position to the retraction position.

By the way, the shorter distance the toner cartridge 70 moves from the mounting position to the retraction position, the shorter the movement time of the toner cartridge 70 can be, and the less time the user waits for the toner cartridge 70 to move. When the amount of movement of the drive rack 15 with respect to the toner cartridge 70k is configured to be larger than the amount of movement of the drive rack 15 with respect to the toner cartridges 70y to 70c, the time the user waits for the toner cartridges 70y to 70c to move can be shortened.

According to the configuration illustrated above, the movement distance L1 can be configured to be longer than the movement distance L2. Such configurations can also be used together.

Although the configuration in which the driven portion has the pinion gear 94 that is engaged with both the drive rack 15 and the rack portion 83 has been described, the driven portion may have a gear that is engaged with the drive rack 15 and a gear that is engaged with the rack portion 83.

The configuration of the movement device 85 that moves the tray 80 is not limited to the so-called rack-and-pinion configuration. For example, the component corresponding to the pinion gear 94 may be replaced by a roller that rotates by receiving the driving of the motor M2, and the tray 80 may be moved in accordance with friction between the roller and the tray 80.

In a case in which a roller that rotates by receiving the driving of the motor M2 is used, the roller and toner cartridge 70 may be brought into contact with each other. In this case, the toner cartridges 70y to 70k can be configured to be directly attached/detached to/from the rotary main body 90 not through the trays 80y to 80k. In this case, the movement device 85 is composed of rollers. Furthermore, the rotary assembly 90A can be regarded to have a rotary main body 90 and toner cartridges 70y to 70k.

Guiding Toner into Discharge Opening of Toner Cartridge Toner housed in the toner accommodating portion 71a is discharged from the discharge opening 71b, and the toner discharged from the discharge opening 71b is housed into the developing accommodating chamber 53a through the reception opening 53b.

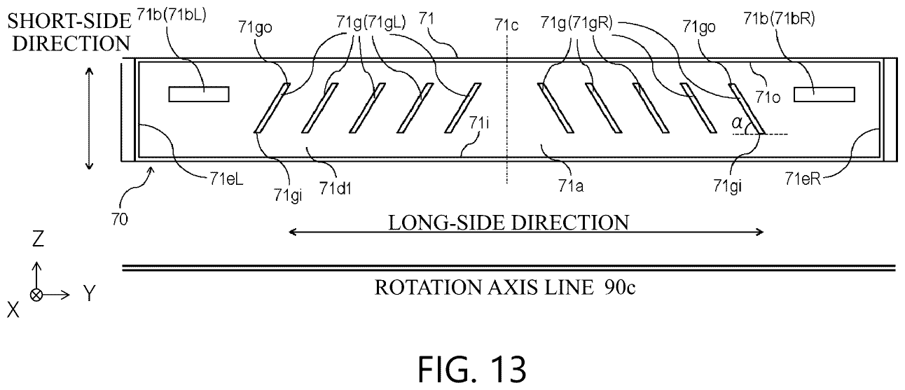

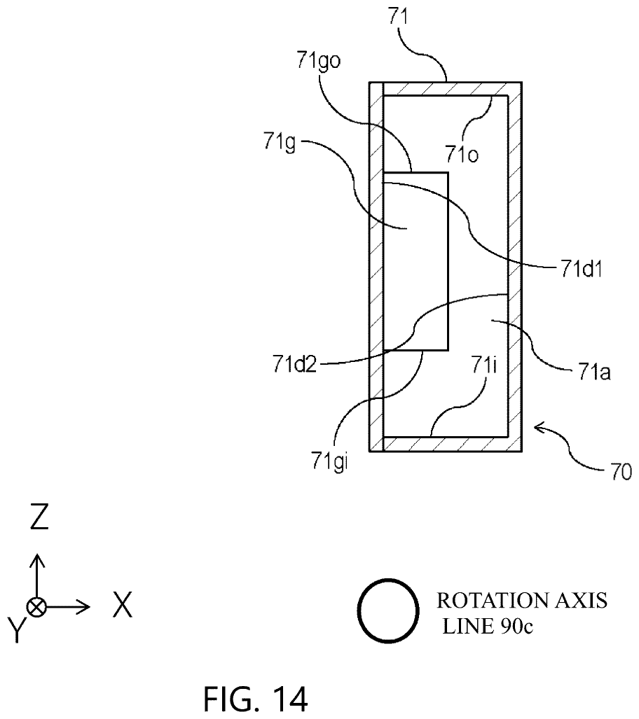

In the following description, the toner cartridge 70 is assumed to be attached to the rotary main body 90. Hereinafter, a configuration for discharging the toner housed in the toner accommodating portion 71a from the discharge opening 71b will be described with reference to FIGS. 13 and 14.

In the following description of the toner cartridge 70, it will be described to be in the posture of being aligned in a Z direction that is a direction perpendicular to a short-side direction of the toner cartridge. Thus, the long-side direction of the toner cartridge is a Y direction, and a thickness direction of the toner cartridge is an X direction that is orthogonal to the Z direction and the Y direction.

FIG. 13 is a diagram illustrating the internal structure of the toner cartridge 70. FIG. 14 is a cross-sectional view in the Y direction that illustrates the internal structure of the toner cartridge 70 and, more specifically, is a cross-sectional view in which a cross-section of the toner cartridge 70 in a direction orthogonal to the rotation axis 90C is viewed in the Y direction.

As illustrated in FIG. 13, a toner frame 71 according to this example has a plurality of discharge openings including a discharge opening (first opening) 71bL and a discharge opening (second opening) 71bR. Each of the discharge openings 71bL and 71bR has a function as a discharge opening 71b communicating with the toner accommodating portion 71a. In the Y direction, the discharge opening 71bL is located at one end with respect to a center 71c of the toner frame 71 and is located between the center 71c and a left side surface 71eL. The discharge opening 71bR is located at the other end with respect to the center 71c of the toner frame 71 and is located between the center 71c and a right side surface 71eR. The discharge opening 71bL is closer to the left side surface 71eL than the center 71c, and the discharge opening 71bR is closer to the right side surface 71eR than the center 71c.

As illustrated in FIG. 14, in this example, a guide portion 71g is disposed on a toner frame inner surface 71d1 inside of the toner frame 71. In other words, the base of the guide portion 71g is connected to the toner frame inner surface 71d1. The toner frame inner surface 71d1 in which the discharge opening 71bL is formed, the toner frame inner surface 71d1 in which a discharge opening 71bR is formed, and the toner frame inner surface 71d1 to which the guide portion 71g is connected may be discontinuous. On the other hand, a gap is formed between the guide portion 71g and the toner frame inner surface 71d1 2.

In this example, the toner frame 71 includes at least one or more left side guides 71gL and at least one or more right-side guides 71gR. The left-side guide 71gL guides toner toward the discharge opening 71bL in the Y direction, and the right-side guide 71gR guides toner toward the discharge opening 71bR in the Y direction.

Although the left-side guide 71gL and the right-side guide 71gR have different directions for guiding toner, the basic configuration and functions thereof are common as a whole. Thus, hereinafter, the left-side guide 71gL and the right-side guide 71gR will be referred to as guide portions 71g, and the discharge opening 71bL and the discharge opening 71bR will be referred to as discharge openings 71b for comprehensive description. Each guide portion 71g is configured to guide toner moving in accordance with its own weight in a direction that intersects the Y direction toward the discharge opening 71b in the Y direction.

As illustrated in FIGS. 13 and 14, the guide portion 71g has an outer end 71go and an inner end 71gi. In the Z direction, the inner end 71gi is closer to the rotation axis 90c than the outer end 71go. In addition, in the Y direction, the inner end 71gi is closer to the discharge opening 71b than the outer end 71go. It is preferable that an angle α between a straight line passing through the inner end 71gi and the outer end 71go and the Y direction, when viewed in a direction perpendicular to the toner frame inner surface 71d1 (a first reception surface), should be larger than the angle of repose of the toner.

As illustrated in FIGS. 13 and 14, the toner frame 71 has a toner accommodating portion 71a and an outer surface 710 and an inner surface 71i facing each other. The outer surface 710 and the inner surface 71i are faces that extend in the X direction and face each other in the Z direction. In the Z direction, the inner surface 71i is closer to the rotation axis 90c than the outer surface 710. In the Z direction, the outer surface 710 is located at one end of the toner accommodating portion 71a, and the inner surface 71i is located at the other end of the toner accommodating portion 71a.

As illustrated in FIGS. 13 and 14, the toner frame 71 has a toner accommodating portion 71a and a toner frame inner surface 71d1 and a toner frame inner surface 71d2 that face each other. The toner frame inner surface 71d1 and the toner frame inner surface 71d2 are faces extending in a direction that intersects (is preferably a direction orthogonal to) the X direction and face each other in the X direction. In the X direction, the toner frame inner surface 71d1 is located at one end of the toner accommodating portion 71a, and the toner frame inner surface 71d2 is located at the other end of the toner accommodating portion 71a.

The guide portion 71g guides toner moving from the outer end 71go toward inner end 71gi in the Z direction toward the discharge opening 71b in the Y direction. In a case in which the toner frame inner surface 71d1 receives the own weight of the toner and is inclined with respect to the horizontal direction, and the inclination angle of the toner frame inner surface 71d1 with respect to the horizontal direction exceeds a predetermined angle, the toner moves on the toner frame inner surface 71d1 along the toner frame inner surface 71d1. At this time, the guide portion 71g guides toner moving along the toner frame inner surface 71d1 toward the discharge opening 71b in the Y direction.

On the other hand, in a case in which the toner frame inner surface 71d2 receives the own weight of the toner and is inclined with respect to the horizontal direction, and the inclination angle of the toner frame inner surface 71d2 with respect to the horizontal direction exceeds a predetermined angle, the toner moves on the toner frame inner surface 71d2 along the toner frame inner surface 71d2. At this time, the toner moves from one of the outer end 71go and the inner end 71gi to the other of the outer end 71go and the inner end 71gi in the Z direction through the gap between the guide portion 71g and the toner frame inner surface 71d2. The toner moving though the gap between the guide portion 71g and the toner frame inner surface 71d2 moves without being guided by the guide portion 71g.

The discharge opening 71b communicates with the reception opening 53b of the developing unit 50, and the toner guided by the guide portion 71g is received in the reception opening 53b through the discharge opening 71b and is housed into the developing accommodating chamber 53a.

### Rotation of Rotary Assembly and Movement of Toner

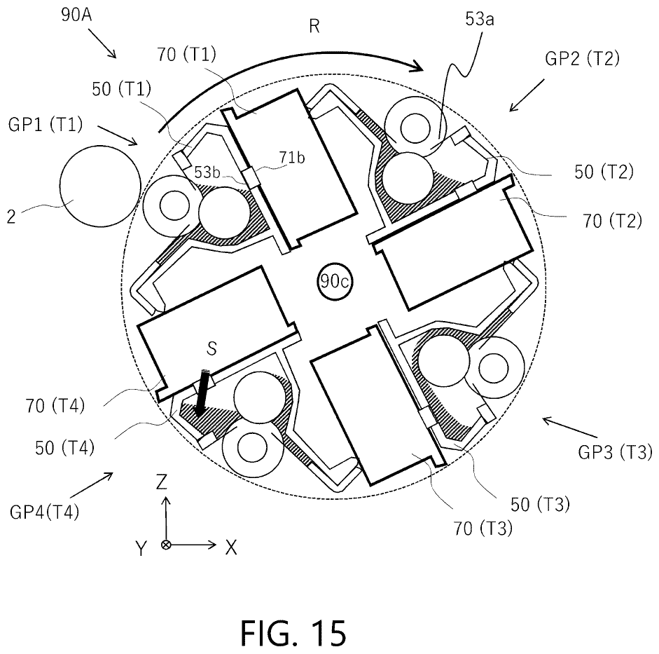

The movement of toner accompanying the rotation of the rotary assembly 90A will be described with reference to FIG. 15. FIG. 15 is a schematic view, which is viewed in the Y direction, illustrating the developing unit 50 rotating around the rotation axis 90C. In FIGS. 15 to 17, diagonal lines drawn inside of the developing accommodating chamber 53a represent an agent surface of toner (a top surface of toner) housed in the developing accommodating chamber 53a or a range in which the toner is present.

In FIG. 15, the rotary assembly 90A rotates in an R direction. FIG. 15 illustrates only one developing unit 50 extracted from among developing units 50y, 50m, and 50c. The developing unit 50 illustrated in the drawing may be any of the developing units 50y, 50m, and 50c. In FIG. 15, for easy understanding, the appearances of the developing unit 50 at four timings (T1, T2, T3, and T4) are virtually illustrated in one drawing. For example, the developing unit 50 at the timing T1 is illustrated as 50 (T1) in the drawing. In the case of the developing unit 50k, the size in the rotary assembly 90A is different from that of the developing units 50y, 50m, and 50c, and the behavior of toner is similar to that illustrated in FIG. 15.

A position GP1 is the position of the developing unit 50 at the timing T1 and is a development position at which the developing unit 50 can develop an electrostatic latent image on the photosensitive drum 2. When the developing unit 50 is at the position GP1, the developing roller 51 faces the photosensitive drum 2. A position GP2 is the position of the developing unit 50 at the timing T2 that is after the timing T1. A position GP3 is the position of the developing unit 50 at the timing T3 that is after the timing T2. A position GP4 is the position of the developing unit 50 at the timing T4 that is after the timing T3. When the developing unit 50 rotates further in the R direction from the position GP4, it returns to the position GP1.

### Toner Replenishment Phases GP3 to GP1

While the developing unit 50 moves from the position GP3 to the position GP1, the toner inside of the toner cartridge 70 is replenished to the developing unit. The toner moves in accordance with its own weight from the discharge opening 71b provided in the toner frame inner surface 71d1 of the toner accommodating portion 71a to the reception opening 53b provided in the developing frame inner surface 53d of the developing frame 53. In other words, the toner inside of the toner cartridge 70 is replenished to the developing unit when the discharge opening 71b is located above the reception opening 53b in the direction of gravity.

In this example, when the developing unit 50 is at the position GP3, the discharge opening 71b is on a lower side of the reception opening 53b in the direction of gravity. Then, after a timing when the developing unit 50 rotates in the R direction and is in the process of moving to the position GP4 (a timing at which the toner frame inner surface 71d1 and the developing frame inner surface 53d are aligned in the Z direction), the discharge opening 71b is located above the reception opening 53b. Thereafter, in a period in which the developing unit 50 rotates and moves to the position GP1 through the position GP4, the discharge opening 71b of the toner cartridge 70c is positioned above the reception opening 53b. Therefore, mainly in this period, toner is discharged from the discharge opening 71b and is supplied to the developing unit 50 (an arrow S at the position GP4). Then, at a timing when the developing unit 50 is in the middle of moving from the position GP1 to the position GP2, the discharge opening 71b is positioned on a lower side of the reception opening 53b in the direction of gravity, and no replenishment is performed.

From the description presented above, a replenishment phase in which toner is replenished is included between the position GP3 and the position GP2, and a main replenishment phase is between the position GP3 to the position GP1. Therefore, when each developing unit 50 comes to the development position (the position GP1), it has already passed through the replenishment phase, and thus a large amount of toner is distributed near the reception opening 53b of the developing accommodating chamber 53a.

Here, in the configuration of this example, during one rotation of the rotary main body 90, there are an area in which drive is transmitted from a motor M3 as a drive source to the supply roller 52 and an area in which no drive is transmitted. The development position is included in the area in which the drive is transmitted. The area in which no drive is transmitted to the supply roller 52 is longer (larger in angle) than the area in which the drive is transmitted.

### Convection of Toner Near Supply Roller

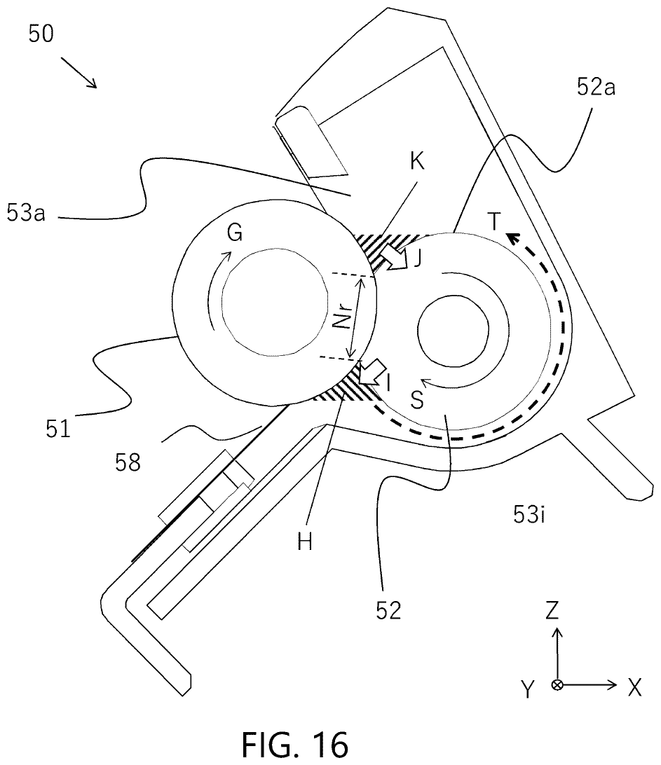

The movement of toner inside of the developing accommodating chamber 53a will be described with reference to FIG. 16. FIG. 16 is a cross-sectional view, viewed in the Y direction, illustrating the internal structure of the developing unit 50 at the development position (the position GP1). The movement of toner inside of the developing accommodating chamber 53a is denoted by each arrow.

The developing roller 51 rotates in the direction of an arrow G, and the supply roller 52 rotates in the direction of an arrow S. The supply roller 52 is a sponge roller, and a foam cell on a supply roller surface 52a is pressed and compressed by the developing roller 51 at a development nip Nr as a nip portion.

When the supply roller surface 52a exits the development nip Nr, the foam cell is released, and toner present in the shaded area K is absorbed and is stored inside of the foam cell (arrow J).

When the surface of the supply roller 52, which has stored toner in the foam cell, rotates in the direction of the arrow S, reaches the development nip Nr again, and begins to be pressed by the developing roller 51, the toner stored inside of the foam cell is discharged to the shaded area H (arrow I).

By continuously performing this series of toner movement, the density of toner in the shaded area H increases and pushes out the surrounding toner, whereby the toner near the supply roller moves in the direction of an arrow T. In this way, movement and circulation of toner replenished from the toner cartridge 70 inside of the developing accommodating chamber 53a accompanied with rotation of the developing roller 51 and the supply roller 52 is also referred to as convection of the toner in the present disclosure.

Here, a configuration in which, by providing a plurality of toner guiding guides having angles intersecting a rotation direction of a rotary inside of a developing unit, toner moving due to its own weight in accordance with rotation of the rotary is guided, and the toner inside of a developing container is uniformized may be considered. However, there are cases in which the developing unit is continuously used in a state in which the rotary is not rotating such as a case in which an image forming operation in a single color on a sheet S, that is, an image forming operation using so-called a mono mode is continuously performed and the like. In this case, a toner guiding effect according to rotation of the rotary is not acquired, and the toner distribution may become non-uniform near the opening portion inside of the developing container and other places. Thus, in the following description, a method of uniformizing toner in accordance with rotation of a supply roller inside of the developing unit separately from uniformization of toner according to the rotation of the rotary will be described.

### Detail of Inside of Developing Unit

A configuration for efficiently moving toner received from the toner cartridge 70 through the reception opening 53b inside of the developing container in the Y direction in a situation in which the developing unit 50 is at the development position will be described.

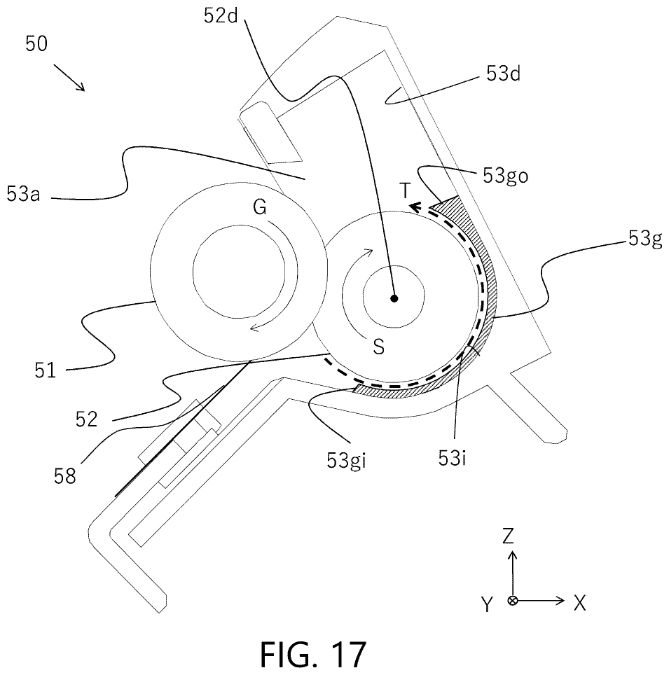

FIG. 17 is a cross-sectional view, viewed in the Y direction, illustrating the internal structure of the developing unit 50 at the development position. FIG. 17 illustrates the internal structure such that the entire one developing guide portion 53g is seen. As illustrated in the drawing, at the development position, a developing blade 58 is located below the developing roller 51 in the vertical direction. At the development position, the developing guide inner end 53gi is located below the developing guide outer end 53go in the vertical direction. At the development position, the developing guide portion 53g has a portion located below the supply roller rotation axis 52d of the supply roller 52 and a portion located above the supply roller rotation axis 52d.

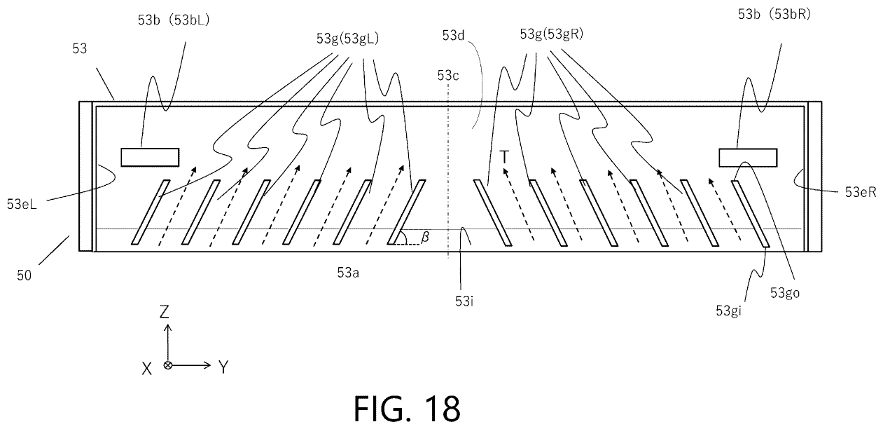

FIG. 18 is a diagram illustrating the internal structure of the developing unit 50 and is a diagram of the developing unit 50, which is at the development position, viewed in the X direction.

As illustrated in FIG. 18, the developing frame 53 according to this example has a developing accommodating chamber 53a and a plurality of reception openings including a reception opening 53bL (a first opening) and a reception opening 53bR (a second opening). Each of the reception openings 53bL and 53bR has a function as a reception opening 53b that causes the developing accommodating chamber 53a to communicate with the toner cartridge 70. Each of the reception openings 53bL and 53bR is provided in the developing frame inner surface 53d of the developing frame 53.

In the Y direction, the reception opening 53bL is located at one end side with respect to the developing central portion 53c of the developing frame 53 and is located between the developing central portion 53c and the developing left side surface 53eL. The reception opening 53bR is located at the other end with respect to the developing central portion 53c of the developing frame 53 and is located between the developing central portion 53c and the developing right side surface 53eR. In this example, in the Y direction, the reception opening 53bL is closer to the developing left side surface 53eL than the developing central portion 53c, and the reception opening 53bR is closer to the developing right side surface 53eR than the developing central portion 53c. A space of the developing frame 53 can be divided into one side (for example, a side including the reception opening 53bL and the developing left-side guide 53gL) as a first portion and the other side (for example, a side including the reception opening 53bR and the developing right-side guide 53gR) as a second portion with the developing central portion 53c as set as a boundary thereof.

As illustrated in FIGS. 17 and 18, the developing frame 53 has a developing accommodating chamber 53a and a supply roller circumference surface 53i (a supply roller facing part) having a shape along the outer circumference surface of the supply roller 52. The supply roller circumference surface 53i and the developing frame inner surface 53d are continuously connected.

As illustrated in FIG. 18, in this example, the developing guide portion 53g is continuously arranged from the supply roller circumference surface 53i inside of the developing frame 53 on the developing frame inner surface 53d. In other words, the base of the developing guide portion 53g is connected to the supply roller circumference surface 53i and the developing frame inner surface 53d. The developing guide portion 53g is a rib (protrusion) continuously protruding from both the supply roller circumference surface 53i and the developing frame inner surface 53d.

The developing guide portion 53g has a developing guide outer end 53go (a first rib end) and a developing guide inner end 53gi (a second rib end). In the rotation direction of the supply roller 52 that is denoted by the arrow S, the developing guide outer end 53go is an end of the upstream side, and the developing guide inner end 53gi is an end of the downstream side. In the Y direction, the developing guide outer end 53go is closer to the reception opening 53b than the developing guide inner end 53gi. A line passing through the developing guide inner end 53gi and the developing guide outer end 53go has a crossing angle β (a developing guide angle) with respect to the Y direction. The developing guide inner end 53gi is located relatively on the inner side in the rotary main body 90 and is closer to the rotation axis 90C. The developing guide outer end 53go is located relatively on the outer side in the rotary main body 90 and is farther from the rotation axis 90C.

In this example, the developing frame 53 includes at least one or more developing left-side guides 53gL and at least one or more developing right-side guides 53gR. In the Y direction, the position of the reception opening 53bR (a range in which the reception opening 53bR is present) and the position of at least one or more developing right-side guides 53gR (a range in which at least one or more developing right-side guides 53gR are present) overlap each other. Similarly, in the Y direction, the position of the reception opening 53bL (a range in which the reception opening 53bL is present) and the position of at least one or more developing left-side guides 53gL (a range in which at least one or more developing left-side guides 53gL is present) overlap each other in the Z direction. A plurality of ribs constituting these plurality of developing guide portions 53g are aligned along the axial direction.

The developing left-side guide 53gL guides toner received from the reception opening 53bL and circulating in movement denoted by the arrow T near the supply roller in a direction away from the reception opening 53bL in the Y direction, that is, in the direction of the developing central portion 53c. The developing right-side guide 53gR guides toner received from the reception opening 53bR and circulating in movement denoted by the arrow T near the supply roller in a direction away from the reception opening 53bR in the Y direction, that is, a direction of the developing central portion 53c.

### Guiding Effect of Developing Guide

Although the developing left-side guide 53gL and the developing right-side guide 53gR have different guiding directions for toner, a basic configuration and functions thereof are common as a whole. Thus, hereinafter, the developing left-side guide 53gL and the developing right-side guide 53gR will be referred to as developing guide portions 53g, and the reception opening 53bL and the reception opening 53bR will be referred to as reception openings 53b in collective description. Each of the developing guide portions 53g is configured to guide toner circulating near the supply roller in accordance with the rotation of the supply roller 52 in a direction away from the reception opening 53b in the Y direction (that is, in this example, in a direction toward the developing central portion 53c).

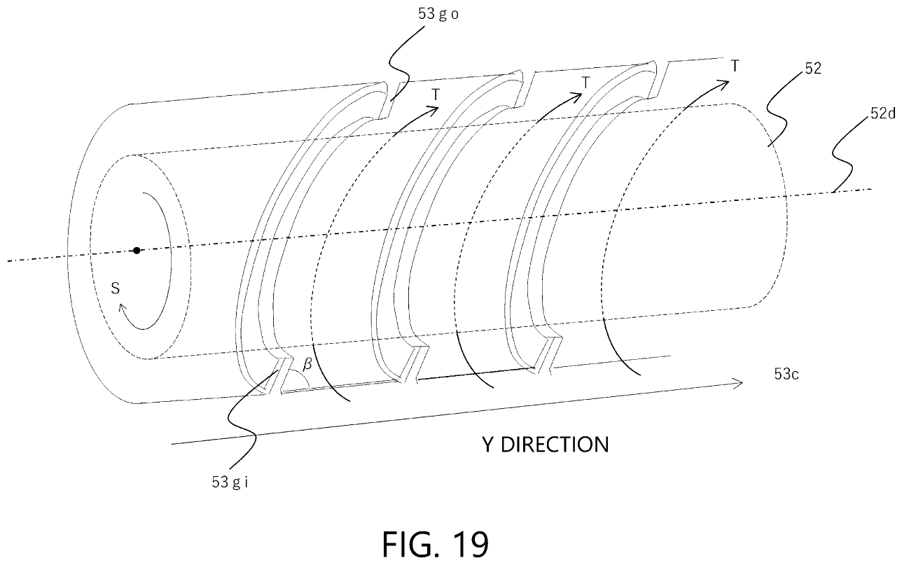

FIG. 19 is a perspective view of the vicinity of the developing guide portion 53g and the supply roller 52. An arrow T represents the movement of toner at a time when toner moving inside of the developing unit is guided by the developing guide portion 53g.

As the supply roller 52 rotates in the S direction around the supply roller rotation axis 52d, the toner circulates in the direction denoted by the arrow T. This toner moves from the developing guide inner end 53gi along the developing guide outer end 53go. At this time, as the toner moves along the developing guide portion 53g having a cross angle β, the toner is guided toward the developing central portion 53c in the Y direction. The supply roller rotation axis 52d is a roller axis that extends along the axial direction of the rotary main body 90.

As described above, according to the configuration of this example, even in a case in which the rotary does not rotate, the developing guide portion 53g guides toner circulating in accordance with the supply roller 52 from the reception opening 53b toward the developing central portion 53c. As a result, the distribution of the amount of toner inside of the developing unit is maintained to be uniform without the toner staying near the reception opening inside of the developing unit.

Here, a time in which the supply roller 52 is rotating during execution of the image forming operation will be represented as a rotation time Rt, and the angular velocity of the rotary main body 90 will be denoted by @. At this time, it is preferable that 360%ω<Rt. In other words, it is preferable that the rotation time of the supply roller 52 should be longer than a time obtained by dividing 360° by the angular velocity ω of the rotary main body 90. Here, the time obtained by dividing 360° by the angular velocity ω of the rotary main body 90 corresponds to a total time in which a state in which the toner is moving on the periphery of the ribs of the developing guide portion 53g during one rotation of the rotary main body 90 is formed. In other words, the time corresponds to a time in which the ribs of the developing guide portion 53g can guide toner in accordance with the rotation of the rotary main body 90. Depending on the posture of the developing unit during rotation of the rotary main body 90, the toner may be guided in a direction approaching the reception opening 53b. By configuring the time in which toner is guided in accordance with the rotation of the supply roller 32 to be longer than the time in which the toner is guided in accordance with the rotation of the rotary main body 90, the toner can be reliably moved away from the reception opening 53b. Thus, when an image forming operation of forming a color image on a sheet S is performed, by satisfying the conditions described above, the time in which the toner is guided in accordance with the rotation of the supply roller 52 can be configured to be reliably longer than the time in which the toner is moved in accordance with the rotation of the rotary main body 90.

### Example 2

Hereinafter, Example 2 will be described. The same reference signs will be assigned to the same configurations as those described in Example 1, and detailed description thereof will be omitted in principle. In this example, the configuration of a developing guide portion 153g is mainly different from that of the developing guide portion 53g according to Example 1.

### Developing Unit of Example 2

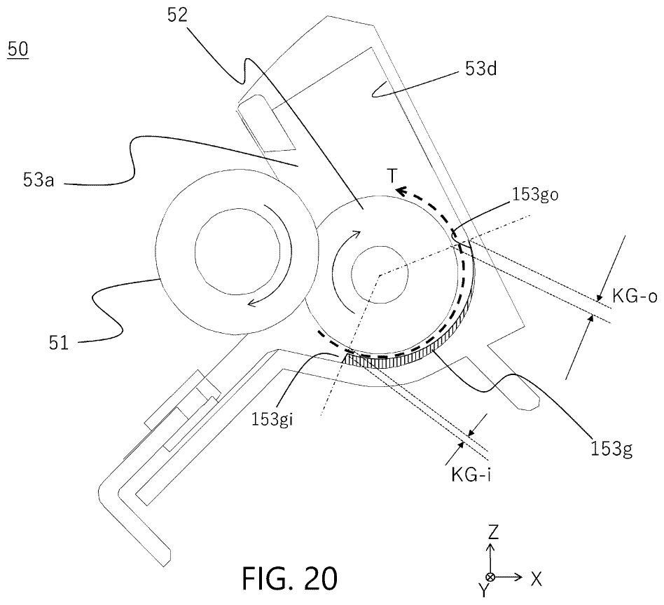

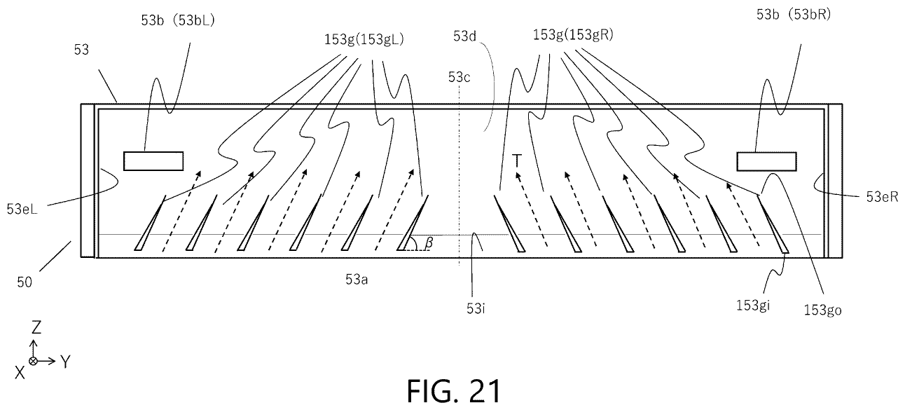

FIG. 20 is a cross-sectional view of the developing unit 50 in the Y direction that illustrates the internal structure of the developing unit 50 at the development position. FIG. 21 is a diagram illustrating the internal structure of the developing unit 50 and is a diagram of the developing unit 50 at the development position seen in the X direction.

As illustrated in FIG. 20, in the developing guide portion 153g of the developing unit 50 according to this example, a distance between the supply roller and the developing guide is widened toward the developing guide outer end 153go from the developing guide inner end 153gi. In accordance with this, uneven development caused by transport marks of the developing guide is suppressed.

As illustrated in FIG. 21, a developing frame 53 according to this example includes a developing accommodating chamber 53a and a plurality of reception openings including a reception opening (first opening) 53bL and a reception opening (second opening) 53bR. Each of the reception openings 53bL and 53bR has a function as a reception opening 53b that communicates with the developing accommodating chamber 53a, and the arrangement and the functions thereof may be similar to those according to Example 1.

The developing guide portion 153g has a developing guide outer end 153go and a developing guide inner end 153gi. In the Y direction, the developing guide outer end 153go is closer to the reception opening 153b than the developing guide inner end 53gi, and a line passing through the developing guide inner end 153gi and the developing guide outer end 53go has a cross angle β in the Z direction.

In this example, a developing frame 53 includes at least one or more developing left-side guides 153gL and at least one or more developing right-side guides 153gR. In the Y direction, the position of the reception opening 53bR (a range in which the reception opening 53bR is present) and the position of at least one or more developing right-side guides 153gR (a range in which at least one or more developing right-side guides 153gR are present) overlap each other. Similarly, in the Y direction, the position of the reception opening 53bL (a range in which the reception opening 53bL is present) and the position of at least one or more developing left-side guides 153gL (a range in which at least one or more developing left-side guides 153gL are present) overlap each other.

The developing left-side guide 153gL guides toner received from the reception opening 53bL and circulating in movement denoted by the arrow T near the supply roller in a direction away from the reception opening 53bL in the Y direction, that is, in the direction of the developing central portion 53c. The developing right-side guide 153gR guides toner received from the reception opening 53bR and circulating in movement denoted by the arrow T near the supply roller in a direction away from the reception opening 53bR in the Y direction, that is, a direction of the developing central portion 53c.

Here, the shortest distance between the supply roller 52 and the developing guide portion 153g is denoted by KG. In this example, as illustrated in FIG. 20, KG becomes wider toward the developing guide outer end 153go from the developing guide inner end 153gi. In other words, the shortest distance KG-o between the developing guide outer end 153go and the supply roller 52 is longer than the shortest distance KG-i between the developing guide inner end 153gi and the supply roller. In other words, a gap between the developing guide portion 153g and the supply roller 52 is the widest at the developing guide outer end 153go.

### Guiding Effect of Developing Guide

Also in this example, although the developing left-side guide 153gL and the developing right-side guide 153gR have different guiding directions for toner, a basic configuration and functions thereof are common as a whole. Thus, hereinafter, the developing left-side guide 153gL and the developing right-side guide 153gR will be referred to as developing guide portions 153g, and the reception opening 53bL and the reception opening 53bR will be referred to as reception openings 53b in collective description.

Each of the developing guide portions 153g is configured to guide toner circulating near the supply roller in accordance with the rotation of the supply roller 52 toward the developing central portion 53c in the Y direction.

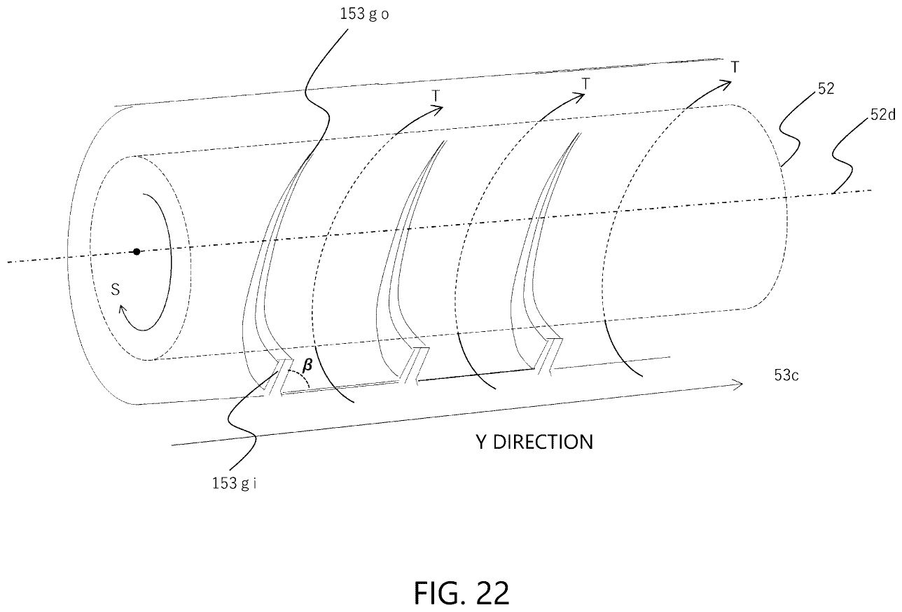

FIG. 22 is a perspective view of the vicinity of the developing guide portion 153g and the supply roller 52 according to Example 2. An arrow T represents the movement of toner at a time when toner moving inside of the developing unit is guided by the developing guide portion 153g.

As the supply roller 52 rotates in the S direction around the supply roller rotation axis 52d, the toner circulates in the direction denoted by the arrow T. This toner moves from the developing guide inner end 153gi along the developing guide outer end 153go. At this time, as the toner is guided along the developing guide portion 153g having a cross angle β, the toner is guided toward the developing central portion 53c in the Y direction.

As described above, according to the configuration of this example, even in a case in which the rotary does not rotate, the developing guide portion 153g guides toner circulating in accordance with the supply roller 52 from the reception opening 53b toward the developing central portion 53c. As a result, the distribution of the amount of toner inside of the developing unit is maintained to be uniform without the toner staying near the reception opening inside of the developing unit.

Furthermore, the distance between the supply roller 52 and the developing guide portion 153g becomes wider toward the developing guide outer end 153go from the developing guide inner end 153gi, whereby uneven development according to the developing guide can be suppressed.

In Examples 1 to 2, although there are two reception openings 53b of the developing unit 50, depending on the configuration, the number of reception openings is not limited thereto and may be arbitrarily set. In addition, the position of the reception opening 53b is not limited to the end of the developing unit 50 in the long-side direction and may be a central portion.

In Examples 1 to 2, the height, the width, and the angle of the plurality of developing guide portions 53g (153g) are constant, and the amount of toner guided in the Y direction is constant. However, since the objective of the present invention is uniformization of the amount of toner inside of the developing container, the height, the width, and the angle of the developing guide portions 53g (153g) may be changed as appropriate in accordance with the configuration of the developing unit 50 for achieving the objective. For example, in the developing central portion 53c, the amount of usage of the toner is large, and thus, in an image forming apparatus in which a decrease in toner is fast, a configuration in which the amount of guided toner according to the developing guide portions 53g (153g) increases toward the developing central portion 53c may be employed.

To the contrary, in a case in which it is necessary to avoid toner consolidation at the developing central portion 53c, a guide configuration in which the amount of guided toner in the Y direction decreases toward the developing central portion 53c may be employed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-075159, filed on May 7, 2024, which is hereby incorporated by reference wherein in its entirety.

What is claimed is:

1. An image forming apparatus comprising:
a photosensitive drum;
a rotary rotatable about a rotation axis extending in an axial direction;
a toner cartridge which is supported by the rotary and includes a discharge opening from which toner is discharged; and
a developing unit which is supported by the rotary and configured to develop an electrostatic latent image formed on the photosensitive drum at a development position, wherein
the developing unit has a receiving opening configured to receive the toner discharged from the discharge opening, an accommodating chamber configured to accommodate the toner received from the receiving opening, a developing roller configured to carry the toner, a supply roller configured to rotate about a roller axis extending along the axial direction to supply the toner accommodated in the accommodating chamber to the developing roller, and a guide portion, and
the guide portion is configured to guide the toner, which moves in a direction intersecting the axial direction in accordance with the rotation of the supply roller, away from the receiving opening in the axial direction.

2. The image forming apparatus according to claim 1,
wherein the guide portion is a rib which protrudes, in an area between an inner surface of the accommodating chamber of the developing unit and the supply roller, from the inner surface of the frame toward the supply roller and extends in the direction intersecting the axial direction.

3. The image forming apparatus according to claim 2,
wherein the rib has a first rib end which is an end on an upstream side in a rotation direction of the supply roller and a second rib end which is an end on a downstream side, and
the toner moves from the second rib end toward the first rib end in accordance with the rotation of the supply roller.

4. The image forming apparatus according to claim 3,
wherein, in a cross-section orthogonal to the axial direction, the shortest distance between an outer circumference of the supply roller and the first rib end is longer than the shortest distance between the outer circumference of the supply roller and the second rib end.

5. The image forming apparatus according to claim 2,
wherein the guide portion includes a plurality of the ribs aligned along the axial direction.

6. The image forming apparatus according to claim 5,
wherein, in a case where one side of the developing unit with respect to a central portion in the axial direction is defined as a first portion and the other portion is defined as a second portion, a first receiving opening is provided in the first portion, and a second receiving opening is provided in the second portion, and
the guide portion includes a first rib that is disposed in the first portion and a second rib that is disposed in the second portion.

7. The image forming apparatus according to claim 2,
wherein the inner surface includes a supply roller opposing portion having a shape extending along an outer circumference surface of the supply roller in a cross-section orthogonal to the axial direction, and
the guide portion is disposed in the supply roller opposing portion.

8. The image forming apparatus according to claim 7,
wherein the guide portion is disposed from a surface on which the receiving opening is provided to the supply roller opposing portion in the developing unit.

9. The image forming apparatus according to claim 2,
wherein the supply roller has a foam body configured to absorb the toner housed in the accommodating chamber on an outer circumference,
the supply roller is configured to rotate while being brought into contact with the developing roller such that a nip portion is formed between the developing roller and the supply roller, and
the toner absorbed by the foam body on a downstream side of the nip portion in the rotation direction of the supply roller is discharged from the foam body on an upstream side of the nip portion to move the toner in a direction intersecting the axial direction.

10. The image forming apparatus according to claim 3,
wherein, in a state in which the developing unit is at the development position, the second rib end is located below the first rib end.

11. The image forming apparatus according to claim 2,
wherein the guide portion has a portion located below the roller axis of the supply roller in a state in which the developing unit is at the development position, and a portion located above the roller axis in the state in which the developing unit is at the development position.

12. The image forming apparatus according to claim 2,
wherein the developing unit has a developing blade regulating a thickness of toner supplied to the developing roller, and, in a state in which the developing unit is at the development position, the developing blade is located below the developing roller.

13. The image forming apparatus according to claim 2,
wherein, when the developing unit is at an attachment and detachment position that is a position different from the development position, the toner cartridge is attachable to and detachable from the developing unit.

14. The image forming apparatus according to claim 13,
wherein a positional relation between the supply roller and the rib is different, in at least one of a vertical direction and a horizontal direction, between a case in which the developing unit is at the development position and a case in which the developing unit is at the attachment and detachment position.

15. The image forming apparatus according to claim 2,
wherein a time in which the supply roller is rotating during execution of the image forming operation is longer than a time acquired by dividing 360 degrees by an angular velocity of the rotary.
